(19) United States
(12) Patent Application Publication
(10) Pub. No.: US 2022/0255849 A1
(43) Pub. Date: Aug. 11, 2022

(54) Data Transmission Method and Apparatus

(71) Applicant: Huawei Technologies Co., Ltd., Shenzhen (CN)

(72) Inventors: Guogang Huang, Shenzhen (CN); Yuchen Guo, Shenzhen (CN); Yunbo Li, Shenzhen (CN); Ming Gan, Shenzhen (CN)

(21) Appl. No.: 17/732,090

(22) Filed: Apr. 28, 2022

Related U.S. Application Data
(63) Continuation of application No. PCT/CN2020/123419, filed on Oct. 23, 2020.

(30) Foreign Application Priority Data
Nov. 6, 2019 (CN) 201911078493.X

(51) Int. Cl. H04L 45/24; H04L 45/74; H04L 47/41

(52) U.S. Cl. CPC H04L 45/24; H04L 47/41; H04L 45/74

(57) ABSTRACT

Application provides a data transmission method and apparatus, to perform data transmission when a plurality of interfaces included by an AP side in packet-level multi-link aggregation belong to different physical devices. The method includes: A first AP generates, and sends a first data frame to a STA carrying a first MSDU, a sequence number of the first MSDU, and a traffic identifier TID of the first MSDU. The first AP generates and sends a second data frame to a second AP. The second data frame includes a third data frame, the third data frame carries a second MSDU, a sequence number of the second MSDU, and a TID of the second MSDU, the TID of the first MSDU is the same as the TID of the second MSDU, and the sequence number of the first MSDU and the sequence number of the second MSDU are allocated based on an obtaining sequence.

### CROSS-REFERENCE TO RELATED APPLICATIONS

This application is a continuation of International Application No. PCT/CN2020/123419, filed on Oct. 23, 2020, which claims priority to Chinese Patent Application No. 201911078493.X, filed on Nov. 6, 2019. The disclosures of the aforementioned applications are hereby incorporated by reference in their entireties.

### FIELD

This application relates to the communication field, and more specifically, to a data transmission method and apparatus in the communication field.

### BACKGROUND

With development of wireless technologies, more wireless devices support multi-band communication, for example, communication simultaneously performed on 2.4 GHz, 5 GHz, and 60 GHz frequency bands. A device that supports the multi-band communication is also referred to as a multi-link device (multi-link device). The multi-link device usually includes a plurality of interfaces.

The multi-link device may be a multi-link access point (access point, AP) device, or may be a multi-link station (station, STA) device. Each STA interface in the multi-link STA device needs to be associated with a corresponding AP interface in the multi-link AP device, so that a plurality of STA interfaces can be connected to a plurality of AP interfaces by using respective communication links, to implement multi-band communication between two devices.

Packet-level (packet-level) multi-link aggregation means that a multi-link device transmits medium access control (medium access control, MAC) service data units (MAC service data unit, MSDU) of a same TID service by using a plurality of communication links, to improve a transmission rate of the TID service.

Collocated (collocated) multi-link aggregation means that a plurality of AP interfaces included by an AP side on which multi-link aggregation is performed belong to a same physical device.

For example, in packet-level and collocated multi-link aggregation, downlink transmission on two communication links is used as an example. A multi-link AP device includes an AP 1 interface and an AP 2 interface, and a multi-link STA device includes a STA 1 interface and a STA 2 interface. The AP 1 interface communicates with the STA 1 interface by using a communication link 1, and the AP 2 interface communicates with the STA 2 interface by using a communication link 2. The multi-link AP device is responsible for receiving a plurality of MSDUs of a traffic identifier (traffic identifier, TID) from an upper layer, sequentially allocating sequence numbers to the plurality of MSDUs based on a receiving sequence, sequentially placing the plurality of MSDUs into a send queue based on the sequence numbers of the plurality of MSDUs, and sending the plurality of MSDUs to which the sequence numbers are allocated to the multi-link STA device by using the communication link 1 (the AP 1 to the STA 1) and the communication link 2 (the AP 2 to the STA 2).

Correspondingly, after receiving the plurality of MSDUs sent by the AP side, the STA 1 interface and the STA 2 interface of the multi-link STA device place the plurality of MSDUs in a receive queue based on a sequence number of each MSDU to complete packet assembly, and send the plurality of MSDUs to a destination address.

In existing packet-level and collocated multi-link aggregation, a to-be-transmitted MSDU and information related to the MSDU are encapsulated between a multi-link AP device and a multi-link STA device by using one layer of 802.11 MAC data frame.

With development of multi-link aggregation technologies, that a multi-link device supports non-collocated (non-collocated) multi-link aggregation means that a plurality of AP interfaces included by an AP side on which multi-link aggregation is performed belong to different physical devices.

However, in packet-level and non-collocated multi-link aggregation, downlink transmission on two communication links is used as an example. An AP 1 interface and an AP 2 interface belong to different AP devices. To be specific, the AP 1 interface belongs to an AP device 1, and the AP 2 interface belongs to an AP device 2. The AP device 1 is a primary AP, and the AP device 2 is a secondary AP. The primary AP communicates with a STA 1 interface in a multi-link STA device by using a communication link 1. The secondary AP communicates with a STA 2 interface in the multi-link STA device by using a communication link 2. The primary AP communicates with the secondary AP by using a communication link 3. The primary AP is responsible for receiving a plurality of MSDUs of a same TID from an upper layer, sequentially allocating sequence numbers to the plurality of MSDUs based on a receiving sequence, sequentially placing the plurality of MSDUs into a send queue based on the sequence numbers of the plurality of MSDUs, sending one part of the plurality of MSDUs to which the sequence numbers are allocated to a STA side by using the communication link 1 (the AP 1 to the STA 1), and sending the other part of the plurality of MSDUs to the STA side by using the communication link 3 and the communication link 2 (the AP 1 to the AP 2 to the STA 2).

In this way, when the MSDU is transmitted between the primary AP and the STA by using the AP 2, an existing method for encapsulating the to-be-transmitted MSDU and information related to the MSDU by using one layer of 802.11 MAC data frame in packet-level and collocated multi-link aggregation is used. After receiving the 802.11 MAC data frame, the AP 2 cannot continue to transmit the MSDU and the information related to the MSDU.

### SUMMARY

Embodiments of this application provide a data transmission method and apparatus, to resolve a problem of how to perform data transmission when a plurality of interfaces included by an AP side in packet-level multi-link aggregation belong to different physical devices.

According to a first aspect, this application provides a data transmission method, and the method includes:

A first AP generates a first data frame. The first data frame carries a first MSDU in a plurality of MSDUs, a sequence number of the first MSDU, and a TID of the first MSDU, TIDs of the plurality of MSDUs are the same, and a sequence number of each of the plurality of MSDUs is allocated based on an obtaining sequence.

The first AP generates a second data frame. The second data frame includes a third data frame, and the third data frame carries a second MSDU in the plurality of MSDUs, a sequence number of the second MSDU, and a TID of the second MSDU.

The first AP sends the first data frame to a STA.

The first AP sends the second data frame to a second AP.

It should be noted that, in a multi-link aggregation process, the first AP is a primary AP, and the second AP is a secondary AP. There is a first communication link between the first AP and the STA, there is a second communication link between the first AP and the STA, and there is a third communication link between the first AP and the second AP.

It should be further noted that, the first communication link and the second communication link may be used for communication by using an 802.11 wireless air interface, and the third communication link may be used for communication by using an 802.11 wireless air interface or a wired DS.

In other words, the first AP, namely, the primary AP, is responsible for receiving a plurality of MSDUs of a same TID from an upper layer, allocating a sequence number to each MSDU based on a receiving sequence of the plurality of MSDUs, encapsulating each MSDU, the sequence number of each MSDU, and the TID of each MSDU into a data frame, and sending a plurality of data frames generated based on the plurality of MSDUs to the STA by separately using two communication links: the first AP to the STA, and the first AP to the second AP to the STA.

In a possible implementation, the third data frame further carries a first receive address, a first transmit address, a destination address, and first Ethertype information, the first receive address is a MAC address of a service access point SAP of a multi-link entity to which the STA belongs, the first transmit address is a MAC address of a SAP of a multi-link entity to which the first AP belongs, the destination address is a MAC address of a destination end of the second MSDU, and the first Ethertype information indicates to process payload by using an IP protocol.

According to the data transmission method provided in embodiments of this application, in packet-level and non-collocated scenarios, APs corresponding to all communication links share one SAP MAC address, and STAs corresponding to all communication links share another SAP MAC address, so that a same frame header address may be used for MSDUs transmitted by using different communication links, that is, there is no need to separately generate frame headers for the MSDUs on different communication links. This improves transmission efficiency.

Optionally, the second data frame may be in a frame format of two-layer encapsulation. A frame format of an 802.11 MAC data frame is used for an inner-layer third data frame, and payload of the third data frame carries the second MSDU, the sequence number of the second MSDU, and the TID of the second MSDU.

Optionally, the frame format of two-layer encapsulation of the second data frame may be in a plurality of forms. This is not limited in embodiments of this application.

In a possible implementation, the second data frame further carries a second receive address, a second transmit address, second Ethertype information, and first payload type information, the second receive address is a MAC address of the second AP, the second transmit address is a MAC address of the first AP, the second Ethertype information indicates to process the first payload type information and the payload by using the 802.11 MAC protocol, and the first payload type information indicates that the payload includes a data frame used for multi-link aggregation.

In a possible implementation, the second data frame further carries a second receive address, a second transmit address, second Ethertype information, and first payload type information, the second receive address is a SAP address of the STA, the second transmit address is a MAC address of the first AP, the second Ethertype information indicates to process the first payload type information and the payload by using the 802.11 MAC protocol, and the first payload type information indicates that the payload includes a data frame used for multi-link aggregation.

According to a second aspect, this application further provides a data transmission method, and the method includes:

A second AP receives a second data frame sent by a first AP. The second data frame includes a third data frame, the third data frame carries a second MSDU in a plurality of MSDUs, a sequence number of the second MSDU, and a TID of the second MSDU, TIDs of the plurality of MSDUs are the same, and a sequence number of each of the plurality of MSDUs is allocated based on an obtaining sequence.

The second AP generates a fourth data frame based on the second data frame. The fourth data frame carries the second MSDU, the sequence number of the second MSDU, and the TID of the second MSDU.

The second AP sends the fourth data frame to the STA. There is a communication link between the first AP and the STA, the communication link is used to transmit a first data frame, and the first data frame carries a first MSDU in the plurality of MSDUs, a sequence number of the first MSDU, and a TID of the first MSDU.

It should be noted that, in a multi-link aggregation process, the first AP is a primary AP, and the second AP is a secondary AP. There is a first communication link between the first AP and the STA, there is a second communication link between the first AP and the STA, and there is a third communication link between the first AP and the second AP.

It should be further noted that, the first communication link and the second communication link may be used for communication by using an 802.11 wireless air interface, and the third communication link may be used for communication by using an 802.11 wireless air interface or a wired DS.

In a possible implementation, the third data frame further carries a first receive address, a first transmit address, a destination address, and first Ethertype information, the first receive address is a MAC address of a service access point SAP of a multi-link entity to which the STA belongs, the first transmit address is a MAC address of a SAP of a multi-link entity to which the first AP belongs, the destination address is a MAC address of a destination end of the second MSDU, and the first Ethertype information indicates to process payload by using an IP protocol.

According to the data transmission method provided in embodiments of this application, in packet-level and non-collocated scenarios, APs corresponding to all communication links share one SAP MAC address, and STAs corresponding to all communication links share another SAP MAC address, so that a same frame header address may be used for MSDUs transmitted by using different communication links, that is, there is no need to separately generate frame headers for the MSDUs on different communication links. This improves transmission efficiency.

In a possible implementation, the second data frame further carries a second receive address, a second transmit address, second Ethertype information, and first payload type information, the second receive address is a MAC address of the second AP, the second transmit address is a MAC address of the first AP, the second Ethertype information indicates to process the first payload type information and the payload by using the 802.11 MAC protocol, and the first payload type information indicates that the payload includes a data frame used for multi-link aggregation.

Optionally, a frame format of one-layer encapsulation (that is, the second AP performs non-transparent transmission) or two-layer encapsulation (that is, the second AP performs transparent transmission) may be used for the fourth data frame. This is not limited in embodiments of this application.

It should be noted that, because the second AP and the STA may communicate with each other by using the 802.11 wireless air interface, the fourth data frame may be a one-layer encapsulated data frame, that is, a frame format of a one-layer 802.11 MAC data frame is used. Alternatively, the fourth data frame may be a two-layer encapsulated data frame, that is, a frame format of an 802.11 MAC data frame is used at both of an outer layer and an inner layer. This is not limited in embodiments of this application.

In a possible implementation, when the fourth data frame is in the frame format of one-layer encapsulation, that the second AP generates a fourth data frame based on the second data frame includes: The second AP generates the fourth data frame based on the second receive address, the second Ethertype information, and the first payload type information.

In other words, after receiving the second data frame, the second AP learns, at a logical link control (logical link control, LLC) layer based on a second receive address field (the MAC address of the second AP) in the second data frame, that a receive end is the second AP; and further determines, based on an Ethertype/Ethertype field (whose value is “0x890d”), to process a payload type field and a payload field by using the 802.11 MAC protocol.

Correspondingly, the second AP generates, at an 802.11 MAC layer, the fourth data frame based on the payload type field (whose value is “ML”, that is, the payload includes the data frame used for multi-link aggregation) and a payload field (the third data frame) of the second data frame. The fourth data frame carries the second MSDU, the sequence number of the second MSDU, and the TID of the second MSDU that are carried in the third data frame.

In a possible implementation, the fourth data frame further carries a third receive address, a third transmit address, the destination address, and the first Ethertype information. The third receive address is a MAC address of the STA, and the third transmit address is the MAC address of the second AP.

In a possible implementation, the second data frame further carries a second receive address, a second transmit address, second Ethertype information, and first payload type information, the second receive address is a SAP address of the STA, the second transmit address is a MAC address of the first AP, the second Ethertype information indicates to process the first payload type information and the payload by using the 802.11 MAC protocol, and the first payload type information indicates that the payload includes a data frame used for multi-link aggregation.

In a possible implementation, when the fourth data frame is in the frame format of two-layer encapsulation, that the second AP generates a fourth data frame based on the second data frame includes: The second AP generates the fourth data frame based on the second receive address, the second Ethertype information, and the first payload type information. The fourth data frame includes the third data frame, the second Ethertype information, and the first payload type information.

In other words, after receiving the second data frame, the second AP learns, at a logical link control (logical link control, LLC) layer based on a second receive address field (the MAC address of the SAP of the multi-link entity to which the STA belongs) in the second data frame, that a receive end is not the second AP, and determines to directly forward a payload field in the second data frame, that is, generates the fourth data frame. The fourth data frame carries the third data frame, the second Ethertype information, and the first payload type information.

In a possible implementation, the fourth data frame further carries a third receive address and a third transmit address. The third receive address is a MAC address of the STA, and the third transmit address is the MAC address of the second AP.

According to a third aspect, this application further provides a data transmission method, and the method includes:

A STA generates a first data frame. The first data frame carries a first MSDU in a plurality of MSDUs, a sequence number of the first MSDU, and a TID of the first MSDU, TIDs of the plurality of MSDUs are the same, and a sequence number of each of the plurality of MSDUs is allocated based on an obtaining sequence.

The STA generates a second data frame. The second data frame carries a second MSDU in the plurality of MSDUs, a sequence number of the second MSDU, and a TID of the second MSDU.

The STA sends the first data frame to a first AP.

The STA sends the second data frame to a second AP.

It should be noted that, in a multi-link aggregation process, the first AP is a primary AP, and the second AP is a secondary AP. There is a first communication link between the first AP and the STA, there is a second communication link between the first AP and the STA, and there is a third communication link between the first AP and the second AP.

It should be further noted that, the first communication link and the second communication link may be used for communication by using an 802.11 wireless air interface, and the third communication link may be used for communication by using an 802.11 wireless air interface or a wired DS.

In other words, the STA is responsible for receiving a plurality of MSDUs of a same TID from an upper layer, allocating a sequence number to each MSDU based on a receiving sequence of the plurality of MSDUs, encapsulating each MSDU, the sequence number of each MSDU, and the TID of each MSDU into a data frame, and sending a plurality of data frames generated based on the plurality of MSDUs to the STA by separately using two communication links: the STA to the first AP, and the STA to the second AP to the first AP.

In a possible implementation, the second data frame further carries a first receive address, a first transmit address, a first destination address, and first Ethertype information, the first receive address is a MAC address of a service access point SAP of a multi-link entity to which the first AP belongs, the first transmit address is a MAC address of a SAP of a multi-link entity to which the STA belongs, the first destination address is a MAC address of a destination end of the second MSDU, and the first Ethertype information indicates to process payload by using an IP protocol.

According to the data transmission method provided in embodiments of this application, in packet-level and non-collocated scenarios, APs corresponding to all communication links share one SAP MAC address, and STAs corresponding to all communication links share another SAP MAC address, so that a same frame header address may be used for MSDUs transmitted by using different communication links, that is, there is no need to separately generate frame headers for the MSDUs on different communication links. This improves transmission efficiency.

In a possible implementation, the second data frame includes a third data frame, and the third data frame carries the second MSDU, the sequence number of the second MSDU, and the TID of the second MSDU.

In other words, a frame format of two-layer encapsulation may be used for the second data frame.

In a possible implementation, the third data frame further carries a first receive address, a first transmit address, a first destination address, and first Ethertype information, the first receive address is a MAC address of a service access point SAP of a multi-link entity to which the first AP belongs, the first transmit address is a MAC address of a SAP of a multi-link entity to which the STA belongs, the first destination address is a MAC address of a destination end of the first MSDU, and the first Ethertype information indicates to process payload by using an IP protocol.

In a possible implementation, the second data frame further carries a second receive address, a second transmit address, a second destination address, second Ethertype information, and first payload type information, the second receive address is a MAC address of the second AP, the second transmit address is a MAC address of the STA, the second destination address is a MAC address of the first AP or the MAC address of the SAP of the multi-link entity to which the first AP belongs, the second Ethertype information indicates to process the first payload type information and the payload by using the 802.11 MAC protocol, and the first payload type information indicates that the payload includes a data frame used for multi-link aggregation.

According to a fourth aspect, this application further provides a data transmission method, and the method includes:

A second AP receives a second data frame sent by a STA. The second data frame carries a second MSDU in a plurality of MSDUs, a sequence number of the second MSDU, and a TID of the second MSDU, TIDs of the plurality of MSDUs are the same, and a sequence number of each of the plurality of MSDUs is allocated based on an obtaining sequence.

The second AP generates a third data frame based on the second data frame. The third data frame carries the second MSDU, the sequence number of the second MSDU, and the TID of the second MSDU.

The second AP sends the third data frame to the first AP. There is a communication link between the first AP and the STA, the communication link is used to transmit a first data frame, and the first data frame carries a first MSDU in the plurality of MSDUs, a sequence number of the first MSDU, and a TID of the first MSDU.

It should be noted that, in a multi-link aggregation process, the first AP is a primary AP, and the second AP is a secondary AP. There is a first communication link between the first AP and the STA, there is a second communication link between the first AP and the STA, and there is a third communication link between the first AP and the second AP.

It should be further noted that, the first communication link and the second communication link may be used for communication by using an 802.11 wireless air interface, and the third communication link may be used for communication by using an 802.11 wireless air interface or a wired DS.

In a possible implementation, the second data frame further carries a first receive address, a first transmit address, a first destination address, and first Ethertype information, the first receive address is a MAC address of a service access point SAP of a multi-link entity to which the first AP belongs, the first transmit address is a MAC address of a SAP of a multi-link entity to which the STA belongs, the first destination address is a MAC address of a destination end of the second MSDU, and the first Ethertype information indicates to process payload by using an IP protocol.

According to the data transmission method provided in embodiments of this application, in packet-level and non-collocated scenarios, APs corresponding to all communication links share one SAP MAC address, and STAs corresponding to all communication links share another SAP MAC address, so that a same frame header address may be used for MSDUs transmitted by using different communication links, that is, there is no need to separately generate frame headers for the MSDUs on different communication links. This improves transmission efficiency.

In a possible implementation, when the second data frame is in a frame format of one-layer encapsulation, that the second AP generates a third data frame based on the second data frame includes: The second AP generates the third data frame based on the first receive address. The third data frame includes the second data frame.

In other words, after receiving the second data frame, the second AP learns, at a logical link control (logical link control, LLC) layer based on the first receive address (the MAC address of the SAP to which the first AP belongs) in the second data frame, that a receive end is not the second AP, and directly forwards payload that is of the second data frame and that is carried in the third data frame.

In a possible implementation, the third data frame further carries a second receive address, a second transmit address, second Ethertype information, and first payload type information, the second receive address is a MAC address of the first AP, the second transmit address is a MAC address of the second AP, the second Ethertype information indicates to process the first payload type information and the payload by using the 802.11 MAC protocol, and the first payload type information indicates that the payload includes a data frame used for multi-link aggregation.

In a possible implementation, the second data frame includes a fourth data frame, and the fourth data frame carries the second MSDU, the sequence number of the second MSDU, and the TID of the second MSDU.

In a possible implementation, the fourth data frame further carries a first receive address, a first transmit address, a first destination address, and first Ethertype information, the first receive address is a MAC address of a service access point SAP of a multi-link entity to which the first AP belongs, the first transmit address is a MAC address of a SAP of a multi-link entity to which the STA belongs, the first destination address is a MAC address of a destination end of the first MSDU, and the first Ethertype information indicates to process payload by using an IP protocol.

In a possible implementation, the second data frame further carries a second receive address, a second transmit address, a second destination address, second Ethertype information, and first payload type information, the second receive address is a MAC address of the second AP, the second transmit address is a MAC address of the STA, the second destination address is a MAC address of the first AP or the MAC address of the SAP of the multi-link entity to which the first AP belongs, the second Ethertype information indicates to process the first payload type information and the payload by using the 802.11 MAC protocol, and the first payload type information indicates that the payload includes a data frame used for multi-link aggregation.

In a possible implementation, when the second data frame is in a frame format of two-layer encapsulation, that the second AP generates a third data frame based on the second data frame includes: The second AP generates the third data frame based on the second receive address, the second destination address, the second Ethertype information, and the first payload type information. The third data frame includes the fourth data frame, the second Ethertype information, and the first payload type information.

In other words, after receiving the second data frame, the second AP learns, at a logical link control (logical link control, LLC) layer based on the second receive address (the MAC address of the second AP) and the second destination address (the MAC address of the first AP) that are in the second data frame, that a receive end is the second AP but a destination end is not the second AP, and directly forwards payload that is of the fourth data frame included in the second data frame and that is carried in the third data frame.

In a possible implementation, the third data frame further carries a third receive address and a third transmit address. The third receive address is a MAC address of the first AP, and the third transmit address is the MAC address of the second AP.

According to a fifth aspect, this application further provides a communication method, and the method includes:

An AP generates a first data frame. The first data frame includes a first management frame, the first management frame carries multi-link establishment request information, the multi-link establishment request information is used to request to establish a plurality of communication links to a STA, the plurality of communication links are used to transmit a plurality of MSDUs belonging to a same TID, and there is a proxy AP on at least one of the plurality of communication links.

The AP sends the first data frame to a first proxy AP. The at least one communication link includes a communication link to which the first proxy AP belongs.

In a possible implementation, the first management frame further carries a first receive address, a first transmit address, a first destination address, and first Ethertype information, the first receive address is a MAC address of a SAP of a multi-link entity to which the STA belongs, the first transmit address is a MAC address of a SAP of a multi-link entity to which the AP belongs, the first destination address is a MAC address of a destination end of multi-link establishment request information, and the first Ethertype information indicates to process payload by using an IP protocol.

In a possible implementation, the first data frame carries a second receive address, a second transmit address, a second destination address, second Ethertype information, and first payload type information, the second receive address is a MAC address of a relay STA of the first proxy AP, the second transmit address is a MAC address of the AP, the second destination address is a MAC address of the STA or the MAC address of the SAP of the multi-link entity to which the STA belongs, the second Ethertype information indicates to process the first payload type information and the payload by using the 802.11 protocol, and the first payload type information indicates that the payload includes a data frame used for multi-link aggregation.

In a possible implementation, the multi-link establishment request information includes link type information of each of the plurality of communication links, and the link type information indicates whether there is a proxy AP on each communication link.

In a possible implementation, when the plurality of communication links include a first communication link, and there is at least one proxy AP on the first communication link, the multi-link establishment request information further includes first link information, and the first link information includes the MAC address of the service access point SAP of the multi-link entity to which the AP belongs, the MAC address of the SAP of the multi-link entity to which the STA belongs, a quantity of the at least one proxy AP, a MAC address of a relay STA and a MAC address of a relay AP that are of each of the at least one proxy AP.

In a possible implementation, when the plurality of communication links include a second communication link, and there is no proxy AP on the second communication link, the multi-link establishment request information further includes second link information, and the second link information includes a MAC address of a first service access point to which the AP belongs and a MAC address of a second service access point to which the STA belongs.

In a possible implementation, the method further includes:

The AP receives a second data frame sent by the STA by using the first proxy AP. The second data frame includes a second management frame, the second management frame carries multi-link establishment response information, and the multi-link establishment response information is used to respond to establishment of the plurality of communication links to the AP.

According to a sixth aspect, this application further provides a communication method, and the method includes:

A first proxy AP receives a first data frame sent by an AP. The first data frame includes a first management frame, the first management frame carries multi-link establishment request information, the multi-link establishment request information is used to request to establish a plurality of communication links to a STA, the plurality of communication links are used to transmit a plurality of MSDUs belonging to a same TID, there is a proxy AP on at least one of the plurality of communication links, and the at least one communication link includes a communication link to which the first proxy AP belongs.

The first proxy AP determines a second data frame based on the first data frame. The second data frame includes the first management frame.

The first proxy AP sends the second data frame to the STA.

In a possible implementation, the first management frame further carries a first receive address, a first transmit address, a first destination address, and first Ethertype information, the first receive address is a MAC address of a SAP of a multi-link entity to which the STA belongs, the second transmit address is a MAC address of a SAP of a multi-link entity to which the AP belongs, the first destination address is a MAC address of a destination end of multi-link establishment request information, and the first Ethertype information indicates to process payload by using an IP protocol.

In a possible implementation, the first data frame carries a second receive address, a second transmit address, a second destination address, second Ethertype information, and first payload type information, the second receive address is a MAC address of a relay STA of the first proxy AP, the second transmit address is a MAC address of the AP, the second destination address is a MAC address of the STA or the MAC address of the SAP of the multi-link entity to which the STA belongs, the second Ethertype information indicates to process the first payload type information and the payload by using the 802.11 protocol, and the first payload type information indicates that the payload includes a data frame used for multi-link aggregation.

In a possible implementation, that the first proxy AP determines a second data frame based on the first data frame includes: The first proxy AP generates the second data frame based on the second receive address, the second destination address, the second Ethertype information, and the first payload type information. The second data frame carries the second Ethertype information and the first payload type information.

In a possible implementation, the second data frame further carries a third receive address and a third transmit address. The third receive address is a MAC address of the STA, and the third transmit address is a MAC address of a relay AP of the first proxy AP.

In a possible implementation, the multi-link establishment request information includes link type information of each of the plurality of communication links, and the link type information indicates whether there is a proxy AP on each communication link.

In a possible implementation, when the plurality of communication links include a first communication link, and there is at least one proxy AP on the first communication link, the multi-link establishment request information further includes first link information, and the first link information includes the MAC address of the service access point SAP of the multi-link entity to which the AP belongs, the MAC address of the SAP of the multi-link entity to which the STA belongs, a quantity of the at least one proxy AP, a MAC address of a relay STA and a MAC address of a relay AP that are of each of the at least one proxy AP.

In a possible implementation, when the plurality of communication links include a second communication link, and there is no proxy AP on the second communication link, the multi-link establishment request information further includes second link information, and the second link information includes a MAC address of a first service access point to which the AP belongs and a MAC address of a second service access point to which the STA belongs.

In a possible implementation, the method further includes: The first proxy AP receives a third data frame sent by the STA based on the second data frame. The third data frame includes a second management frame, the second management frame carries multi-link establishment response information, and the multi-link establishment response information is used to respond to establishment of the plurality of communication links to the AP.

According to a seventh aspect, this application provides an apparatus, configured to perform the method according to any one of the foregoing aspects or the possible implementations of the foregoing aspects. Specifically, the apparatus may include a unit configured to perform the method according to any one of the foregoing aspects or the possible implementations of the foregoing aspects.

According to an eighth aspect, this application further provides an apparatus. The apparatus includes a memory, a processor, a transceiver, and instructions that are stored in the memory and that can be run on the processor. The memory, the processor, and the communication interface communicate with each other by using an internal connection path. The processor executes the instructions, to enable the apparatus to implement the method according to any one of the foregoing aspects or the possible implementations of the foregoing aspects.

According to a ninth aspect, this application further provides a computer-readable storage medium, configured to store a computer program. The computer program includes instructions used to implement the method according to any one of the foregoing aspects or the possible implementations of the foregoing aspects.

According to a tenth aspect, this application further provides a computer program product including instructions. When the computer program product runs on a computer, the computer is enabled to implement the method according to any one of the foregoing aspects or the possible implementations of the foregoing aspects.

According to an eleventh aspect, this application further provides a chip apparatus, including an input interface, an output interface, at least one processor, and a memory. The input interface, the output interface, the processor, and the memory communicate with each other by using an internal connection path. The processor is configured to execute code in the memory. When the processor executes the code, the chip apparatus implements the method according to any one of the foregoing aspects or the possible implementations of the foregoing aspects.

### BRIEF DESCRIPTION OF THE DRAWINGS

FIG. 1 is a schematic diagram of a multi-link device according to an embodiment of this application;

FIG. 2 is a schematic diagram of multi-link aggregation at a same location according to an embodiment of this application;

FIG. 3 is a schematic diagram of multi-link aggregation at different locations according to an embodiment of this application;

FIG. 4 is a schematic diagram of packet-level multi-link aggregation according to an embodiment of this application;

FIG. 5 is a schematic diagram of a service access point of a multi-link entity of flow-level multi-link aggregation according to an embodiment of this application;

FIG. 6 is a schematic diagram of a service access point of a multi-link entity of packet-level multi-link aggregation according to an embodiment of this application;

FIG. 7 is a frame format of an 802.11 MAC data frame according to an embodiment of this application;

FIG. 8 is a frame format of an Ethernet data frame according to an embodiment of this application;

FIG. 9 is a frame format of an 802.11 MAC action frame according to an embodiment of this application;

FIG. 10A and FIG. 10B are a schematic flowchart of a data transmission method 100 according to an embodiment of this application;

FIG. 11 is a schematic diagram of a frame format of a first data frame according to an embodiment of this application;

FIG. 12 is a schematic diagram of a frame format of a second data frame according to an embodiment of this application;

FIG. 13 is a schematic diagram of another frame format of a second data frame according to an embodiment of this application;

FIG. 14 is a schematic diagram of still another frame format of a second data frame according to an embodiment of this application;

FIG. 15 is a schematic diagram of still another frame format of a second data frame according to an embodiment of this application;

FIG. 16 is a schematic diagram of a frame format of a fourth data frame according to an embodiment of this application;

FIG. 17 is a schematic diagram of another frame format of a fourth data frame according to an embodiment of this application;

FIG. 18A and FIG. 18B are a schematic flowchart of a data transmission method 200 according to an embodiment of this application;

FIG. 19 is a schematic diagram of a frame format of a first data frame according to an embodiment of this application;

FIG. 20 is a schematic diagram of a frame format of a second data frame according to an embodiment of this application;

FIG. 21 is a schematic diagram of another frame format of a second data frame according to an embodiment of this application;

FIG. 22 is a schematic diagram of a frame format of a third data frame according to an embodiment of this application;

FIG. 23 is a schematic diagram of another frame format of a third data frame according to an embodiment of this application;

FIG. 24 is a schematic diagram of multi-link aggregation at a same location according to an embodiment of this application;

FIG. 25 is a schematic flowchart of a communication method 300 according to an embodiment of this application;

FIG. 26 is a schematic diagram of a frame format of a first data frame according to an embodiment of this application;

FIG. 27 is a schematic diagram of a frame format of a second data frame according to an embodiment of this application;

FIG. 28 is a schematic block diagram of a data transmission apparatus 400 according to an embodiment of this application;

FIG. 29 is a schematic block diagram of a data transmission apparatus 500 according to an embodiment of this application;

FIG. 30 is a schematic block diagram of a data transmission apparatus 600 according to an embodiment of this application;

FIG. 31 is a schematic block diagram of a data transmission apparatus 700 according to an embodiment of this application;

FIG. 32 is a schematic block diagram of a communication apparatus 800 according to an embodiment of this application;

FIG. 33 is a schematic block diagram of a communication apparatus 900 according to an embodiment of this application;

FIG. 34 is a schematic block diagram of an access point 1000 according to an embodiment of this application;

FIG. 35 is a schematic block diagram of an access point 1100 according to an embodiment of this application;

FIG. 36 is a schematic block diagram of a station 1200 according to an embodiment of this application;

FIG. 37 is a schematic block diagram of an access point 1300 according to an embodiment of this application;

FIG. 38 is a schematic block diagram of an access point 1400 according to an embodiment of this application; and

FIG. 39 is a schematic block diagram of an access point 1500 according to an embodiment of this application.

### DETAILED DESCRIPTION

The following describes the technical solutions in embodiments of this application with reference to the accompanying drawings in embodiments of this application.

For clarity, some terms in embodiments of this application are first explained and described.

1. Multi-Link (Multiple-Link, ML) Device

That the multi-link device supports multi-band communication means that one physical device has a plurality of interfaces at the same time, and the multi-link device may simultaneously perform communication by using the plurality of interfaces. The plurality of interfaces operate on different channels.

It should be noted that the multi-link device may be a multi-link AP device or a multi-link STA device. Each STA interface in the multi-link STA device needs to be associated with a corresponding AP interface in the multi-link AP device, so that a plurality of STA interfaces can be connected to a plurality of AP interfaces by using respective communication links, to implement multi-band communication between two devices.

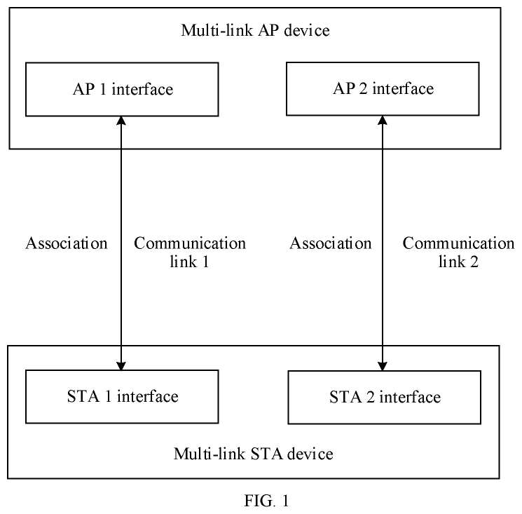

For example, as shown in FIG. 1, the multi-link AP device includes two interfaces: an AP 1 interface and an AP 2 interface, and the multi-link STA device includes two interfaces: a STA 1 interface and a STA 2 interface. After the STA 1 interface is associated with the AP 1 interface and the STA 2 interface is associated with the AP 2 interface, the STA 1 interface and the AP 1 interface may communicate with each other by using a communication link 1, and the STA 2 interface and the AP 2 interface may communicate with each other by using a communication link 2, so that the multi-link AP device and the multi-link STA device communicate with each other by using both of the communication link 1 and the communication link 2.

2. Multi-Link Aggregation

In the multi-link aggregation, a plurality of interfaces are aggregated to implement payload sharing of incoming or outgoing traffic (throughput) between member interfaces, to increase a transmission rate.

A. Based on whether a plurality of AP interfaces included by an AP side on which multi-link aggregation is performed belong to a same physical device, multi-link aggregation may be classified into the following types:

(a) Collocated (collocated) multi-link aggregation means that the plurality of AP interfaces included by the AP side on which multi-link aggregation is performed belong to the same physical device.

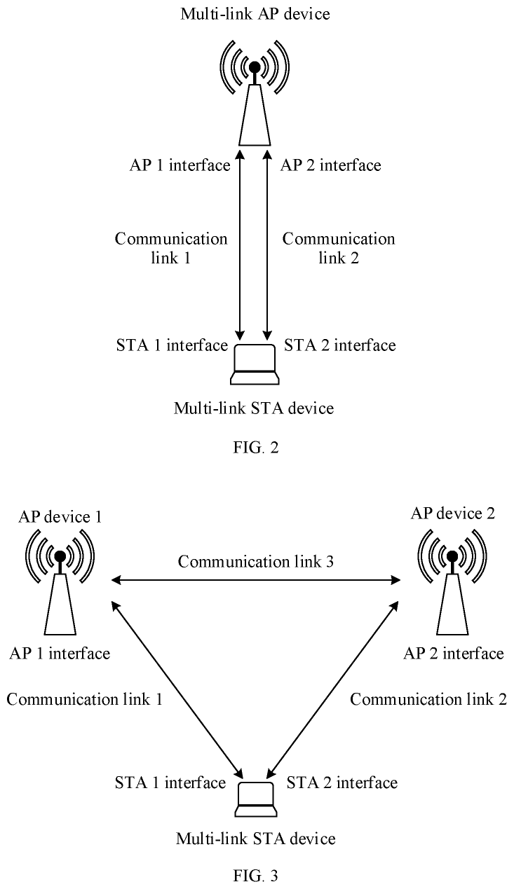

FIG. 2 is a collocated multi-link aggregation scenario. As shown in FIG. 2, the AP side on which multi-link aggregation is performed includes an AP 1 interface and an AP 2 interface, and a STA side on which multi-link aggregation is performed includes a STA 1 interface and a STA 2 interface. The STA 1 interface communicates with the AP 1 interface by using a communication link 1, and the STA 2 interface communicates with the interface AP 2 by using a communication link 2. Both of the AP 1 interface and the AP 2 interface belong to a same multi-link AP device.

(b) Non-collocated (non-collocated) multi-link aggregation means that the plurality of AP interfaces included by the AP side on which multi-link aggregation is performed belong to different physical devices.

FIG. 3 is a non-collocated multi-link aggregation scenario. As shown in FIG. 3, the AP side on which multi-link aggregation is performed includes an AP 1 interface and an AP 2 interface, and a STA side on which multi-link aggregation is performed includes a STA 1 interface and a STA 2 interface. The STA 1 interface communicates with the AP 1 interface by using a communication link 1, and the STA 2 interface communicates with the AP 2 interface by using a communication link 2. The AP 1 interface belongs to an AP device 1, and the AP 2 interface belongs to an AP device 2. In other words, the AP 1 and the AP 2 belong to different AP devices.

B. Based on whether traffic identifiers (traffic identifier, TID) of a media access control (medium access control, MAC) service data unit (MAC service data unit, MSDU) transmitted by using the multi-link aggregation are the same, the multi-link aggregation may be classified into the following types:

(a) Flow-level (flow-level) multi-link aggregation means that a multi-link device transmits MSDUs of different TIDs by using a plurality of communication links, to improve data transmission efficiency.

(b) Packet-level (packet-level) multi-link aggregation means that a multi-link device transmits MSDUs of a same TID service by using a plurality of communication links, to improve a transmission rate of the TID service.

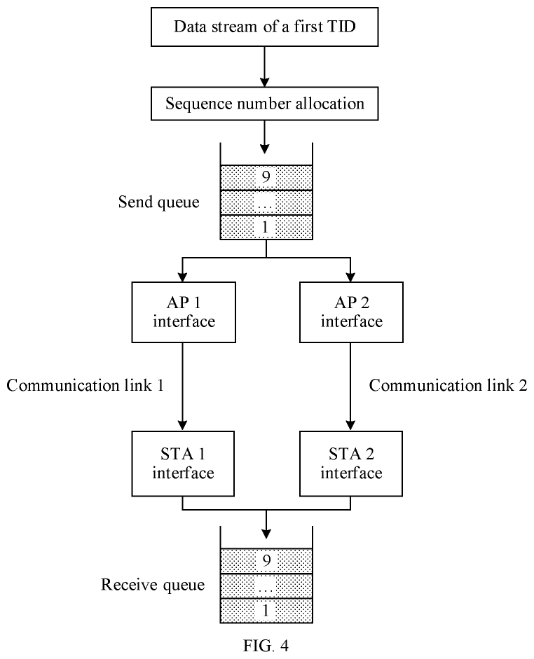

FIG. 4 is a packet-level multi-link aggregation scenario. As shown in FIG. 4, the AP side on which packet-level multi-link aggregation is performed includes the AP 1 interface and the AP 2 interface, and the STA side includes the STA 1 interface and the STA 2 interface. The AP 1 interface communicates with the STA 1 interface by using a communication link 1, and the AP 2 interface communicates with the STA 2 interface by using a communication link 2. The communication link 1 and the communication link 2 share one send queue, one receive queue, and one sequence counter. Data packets (for example, high-priority voice and video data packets) of a first TID are allowed to be simultaneously sent on the communication link 1 and the communication link 2, to reduce a packet delay.

It should be noted that, in packet-level and non-collocated multi-link aggregation scenarios, an AP side on which multi-link aggregation is performed may be classified into a primary AP and at least one secondary AP. The primary AP is responsible for management and control in a multi-link aggregation process, for example, data packet summarization, sequence number allocation, block acknowledgment generation, and the like. A link connected to the primary AP is referred to as a primary link, and another link is referred to as a secondary link.

For example, two communication links are used as an example, two AP interfaces are included by an AP side on which packet-level and non-collocated multi-link aggregation are performed. The two AP interfaces belong to different AP devices. One AP device is a primary AP, and the other AP device is a secondary AP. The primary AP communicates with a STA 1 interface in a multi-link STA device by using a communication link 1, the secondary AP communicates with a STA 2 interface in the multi-link STA device by using a communication link 2, and the primary AP communicates with the secondary AP by using a communication link 3. The primary AP is responsible for receiving a plurality of MSDUs of a same TID from an upper layer, sequentially allocating sequence numbers to the plurality of MSDUs based on a receiving sequence, sequentially placing the plurality of MSDUs into a send queue based on the sequence numbers of the plurality of MSDUs, sending the plurality of MSDUs to which the sequence numbers are allocated to a STA side by using the communication link 1, and sending the plurality of MSDUs to the STA side by using the communication link 3 and the communication link 2. Correspondingly, the STA side places the plurality of MSDUs into a receive queue based on a sequence number of each of the received MSDUs, and sends the plurality of MSDUs to a destination address.

3. Multi-Link Entity to which an Interface in Multi-Link Aggregation Belongs and Service Access Point (Service Access Point, SAP) of the Multi-Link Entity

The multi-link entity is a logical entity. A SAP of the multi-link entity is a logical interface where two adjacent layers interact (exchange information) with each other.

It should be noted that a MAC layer may be classified into a high (high) MAC and at least one low (low) MAC. A data packet received at an LLC layer is delivered to the high MAC layer by using the SAP. The high MAC allocates a sequence number to the data packet, and then delivers the data packet to a corresponding low MAC for transmission by using an interface.

A. Flow-level multi-link aggregation: Each interface included by each side on which flow-level multi-link aggregation is performed belongs to an independent multi-link entity, each multi-link entity has an independent service access point, and each multi-link entity communicates with an upper layer by using its own service access point.

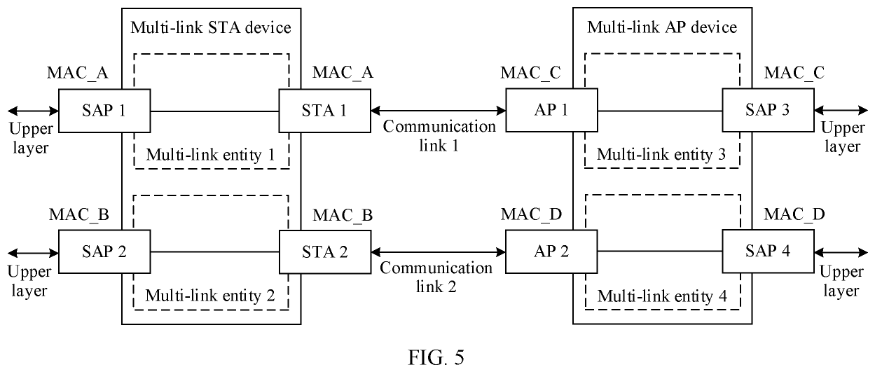

For example, as shown in FIG. 5, an AP side on which multi-link aggregation is performed includes an AP 1 interface and an AP 2 interface, and a STA side includes a STA 1 interface and a STA 2 interface. The AP 1 interface communicates with the STA 1 interface by using a communication link 1, and the AP 2 interface communicates with the STA 2 interface by using a communication link 2. The STA 1 belongs to a multi-link entity 1, and the multi-link entity 1 communicates with the upper layer (LLC layer) by using a SAP 1. The STA 2 belongs to a multi-link entity 2, and the multi-link entity 2 communicates with the upper layer by using a SAP 2. The AP 1 belongs to a multi-link entity 3, and the multi-link entity 3 communicates with the upper layer by using a SAP 3. The AP 2 belongs to a multi-link entity 4, and the multi-link entity 4 communicates with the upper layer by using a SAP 4.

B. Service access point in packet-level multi-link aggregation: All interfaces included by each side on which packet-level multi-link aggregation is performed belong to a same multi-link entity, the multi-link entity has an independent service access point, and the multi-link entity communicates with the upper layer by using its own service access point.

It should be noted that in the multi-link entity, all links share one BA session, one sequence counter, and one packet calculator.

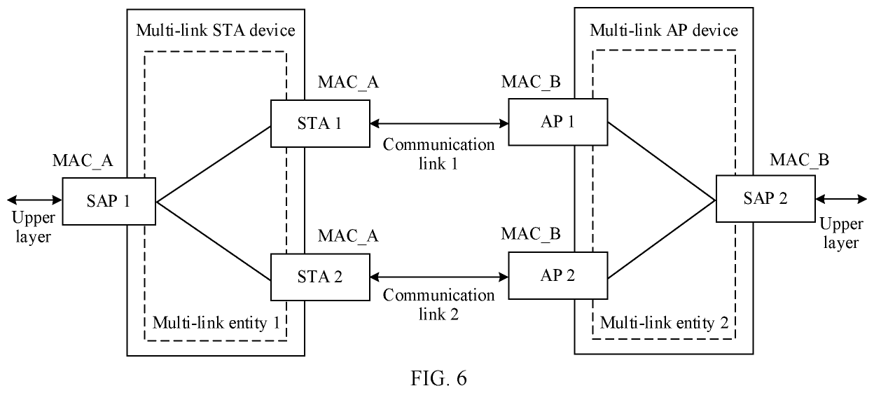

For example, as shown in FIG. 6, an AP side on which multi-link aggregation is performed includes an AP 1 interface and an AP 2 interface, and a STA side includes a STA 1 interface and a STA 2 interface. The AP 1 interface communicates with the STA 1 interface by using a communication link 1, and the AP 2 interface communicates with the STA 2 interface by using a communication link 2. The STA 1 interface and the STA 2 interface belong to a multi-link entity 1, and the multi-link entity 1 communicates with the upper layer (LLC layer) by using a SAP 1. The AP 1 interface and the AP 2 interface belong to a multi-link entity 2, and the multi-link entity 2 communicates with the upper layer by using a SAP 2.

Optionally, a MAC address of a SAP may be a MAC address of an interface of the SAP, or may be a reallocated MAC address. This is not limited in embodiments of this application.

It should be noted that in FIG. 1 to FIG. 6, multi-link aggregation on only two communication links is used as an example. The multi-link aggregation may further include another quantity of communication links. This is not limited in embodiments of this application.

It should be noted that, in embodiments of this application, communication between an AP side and a STA side, for example, the communication link 1 and the communication link 2 in FIG. 2 and FIG. 3, may be performed by using 802.11. Communication between APs on an AP side, for example, the communication link 3 in FIG. 3, may be performed by using an 802.11 wireless air interface or a wired distributed system (distributed system, DS).

4. Frame Format of an 802.11 MAC Data Frame

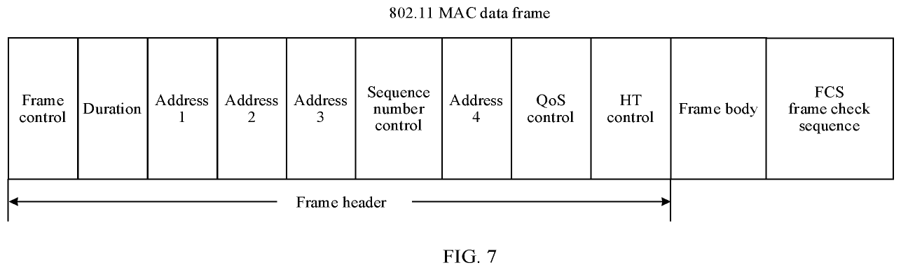

FIG. 7 is the frame format of the 802.11 MAC data frame. The 802.11 MAC data frame includes the following fields.

(1) Frame control (frame control) includes a protocol version (protocol version), a type (type), a subtype (subtype), and To DS/From DS.

It should be noted that, MAC frames in 802.11 may be classified into the following three types based on different functions of frames:
A control frame is used for handshake communication and forward acknowledgment during contention, and for ending a contention-free period.
A management frame is used for negotiation and relationship control, for example, association, authentication, synchronization, and the like, between a STA and an AP.
A data frame is used to transmit data in a contention period and a contention-free period.

It should be further noted that the type (type field) and the subtype (subtype field) in the frame control (frame control field) jointly indicate a frame type. When a B3 bit and a B2 bit of the type are 00, the frame is a management frame; and when the B3 bit and the B2 bit of the type are 01, the frame is a control frame; and when the B3 bit and the B2 bit of the type are 10, the frame is a data frame. The subtype is further used to determine the frame type. For example, the management frame is divided into association and authentication frames.

It should be noted that To DS/From DS indicates a sending direction of an MSDU, and four possible cases are discussed:
When To DS=0 and From DS=0, it indicates that the data frame is transmitted between network hosts.
When To DS=0 and From DS=1, it indicates that the data frame is from an AP.
When To DS=1 and From DS=0, it indicates that the data frame is sent to an AP.
When To DS=1 and From DS=1, it indicates that the data frame is sent from an AP to an AP.

(2) Duration (duration).

(3) An address 1 (address 1) is used to carry a receive address, namely, an RA (receiver address).

(4) An address 2 (address 2) is used to carry a transmit address, namely, a TA (transmitter address).

(5) An address 3 (address 3) is used to carry a destination address, namely, a DA (destination address).

(6) Sequence number (sequence, SN) control (sequence control) is used to carry a sequence number.

(7) An address 4 (address 4) is used to carry a source address, namely, an SA (source address).

It should be noted that for some frame types, some fields in the frame format of the 802.11 MAC data frame do not exist. For example, for the data frame, when From DS=0 and To DS=1 in the frame control field, the address 4 field does not exist. The address 4 field is usually used for relay transmission.

For example, in a wireless distribution system (wireless distribution system, WDS) mode, the data frame has four addresses. The RA and the TA are used to indicate a receive end and a transmit end, and the two addresses are used for wireless transmission. The other two addresses are the DA and the SA, which are used to indicate the source address and the destination address respectively. This is the same as a DA and an SA used on the Ethernet.

For example, an AP 1 has a STA 1, and an AP 2 has a STA 2. If the STA 1 needs to communicate with the STA 2, the STA 1 first sends a data frame to the AP 1, and then the AP 1 sends the frame to the AP 2. In this case, the data frame has four addresses: an RA=mac (AP 2), a TA=mac (AP 1), a DA=mac (STA 2), and an SA=mac (STA 1).

(8) Quality of service (quality of service, QoS) control (QoS control) is used to carry a TID.

(9) High throughput (high throughput, HT) control (HT control).

(10) A frame body (frame body) is used to carry an MSDU.

It should be noted that the frame body includes an LLC frame header and payload. The payload is used to carry an MSDU, the LLC frame header includes a destination service access point (destination service access point, DSAP), a source service access point (source service access point, S SAP), control, a vendor organizationally unique identifier (vendor organizationally unique identifier), and an Ethertype (ethertype type). The vendor organizationally unique identifier is a fixed bit 0x000000.

(11) An FCS frame check sequence (frame check sequence, FCS) is used to determine whether an error occurs in a data frame.

Optionally, because some fields in a frame header of the 802.11 MAC data frame are meaningful only for a transmit end and a receive end, in some cases, for example, if the transmit end and the receive end are not concerned, the frame header of the 802.11 MAC data frame may be simplified. In other words, the simplified 802.11 MAC frame header may include only the fields described in (1), (3) to (6), and (8).

5. Frame Format of an Ethernet Data Frame

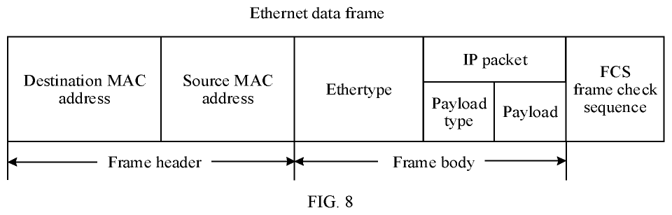

FIG. 8 is a frame format of an Ethernet data frame. The Ethernet data frame includes the following fields:

(1) A destination MAC address (destination MAC) is used to carry a receive address.

(2) A source MAC address (source MAC) is used to carry a transmit address.

(3) Ethertype is used to carry Ethertype information.

It should be noted that when a PDU (protocol data unit) arrives at a layer, the layer needs to deliver the PDU to an upper layer. There are many upper layer protocols. Therefore, during data processing, a field is required to identify an upper layer to which the PDU is delivered.

For example, a value of the Ethertype information is “0x890d”, and this indicates that valid payload is delivered to an 802.11 MAC layer for processing; and a value of the Ethertype information is “0x0800”, and this indicates that valid payload is delivered to an IP layer for processing.

(4) An Internet protocol (Internet protocol, IP) packet (IP packet) is also referred to as valid payload, including the following fields:
A payload type (payload type) is used to carry payload type information. The payload type defines a new value. For example, the value is “ML”, and this indicates that payload carries information related to multi-link aggregation.
Payload (payload) is used to carry an MSDU.

(5) An FCS frame check sequence is used to determine whether an error occurs in a received frame.

6: Frame Format of an 802.11 MAC Management Frame

It should be noted that the 802.11 MAC management frame includes an 802.11 MAC action frame.

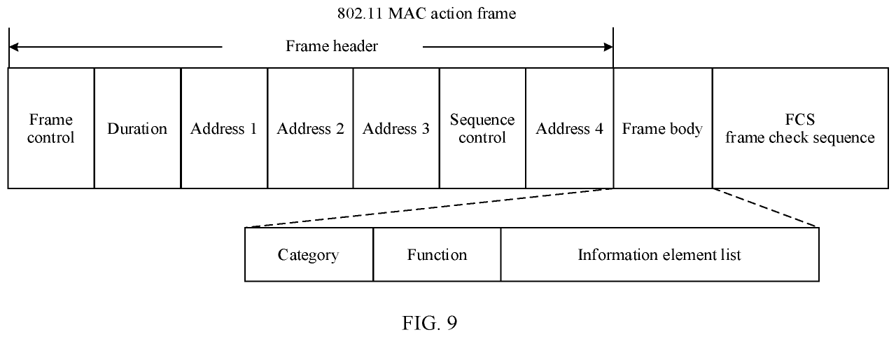

FIG. 9 is a frame format of the 802.11 MAC action frame. The 802.11 MAC action frame includes the following fields:

(1) Frame control/Frame control includes a protocol version/protocol version, a type/type, and a subtype/subtype.

(2) Duration (duration).

(3) An address 1 (address 1) is used to carry a receive address, namely, an RA (receiver address).

(4) An address 2 (address 2) is used to carry a transmit address, namely, a TA (transmitter address).

(5) An address 3 (address 3) is used to carry a destination address, namely, a DA (destination address).

(6) Sequence number control (sequence control) is used to carry a sequence number.

(7) An address 4 (address 4) is used to carry a source address, namely, an SA (source address).

(8) A frame body (frame body) includes (a) a category, (b) a function, and (c) an information element list.

(9) An FCS frame check sequence is used to determine whether an error occurs in a received frame.

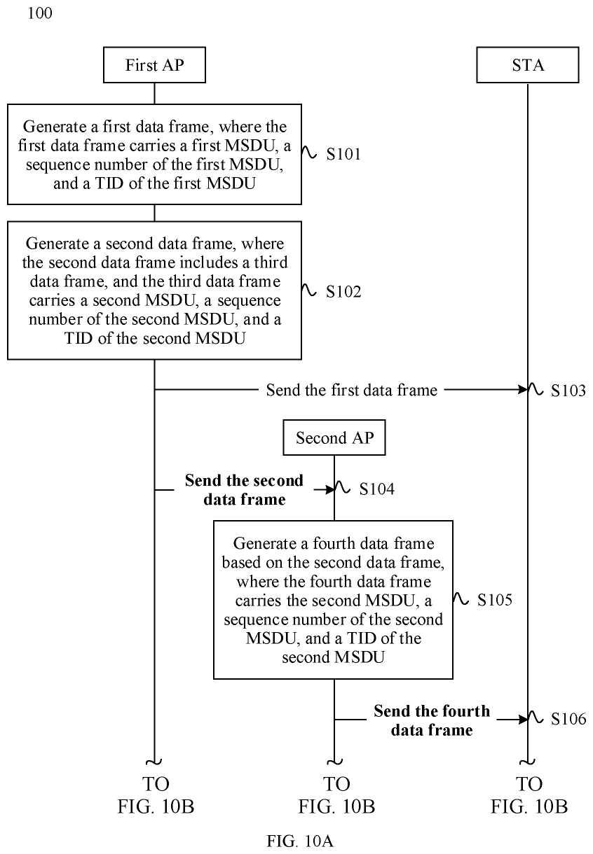

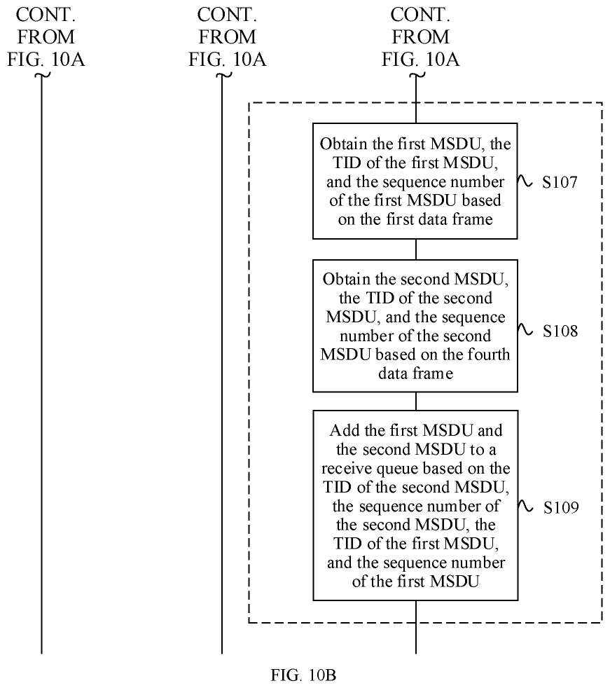

FIG. 10A and FIG. 10B are a schematic flowchart of a data transmission method 100 according to an embodiment of this application. The method 100 may be applicable to packet-level and non-collocated multi-link aggregation downlink transmission scenarios.

S101: A first access point AP generates a first data frame, where the first data frame carries a first media access control service data unit MSDU, a sequence number of the first MSDU, and a traffic identifier TID of the first MSDU.

S102: The first AP generates a second data frame, where the second data frame includes a third data frame, the third data frame carries a second MSDU, a sequence number of the second MSDU, and a TID of the second MSDU, the TID of the first MSDU is the same as the TID of the second MSDU, and the sequence number of the first MSDU and the sequence number of the second MSDU are allocated based on an obtaining sequence.

S103: The first AP sends the first data frame to a STA, and correspondingly the STA receives the first data frame sent by the first AP.

S104: The first AP sends the second data frame to a second AP, and correspondingly the second AP receives the second data frame sent by the first AP.

It should be noted that, in a multi-link aggregation process, the first AP is a primary AP, and the second AP is a secondary AP. There is a first communication link between the first AP and the STA, there is a second communication link between the first AP and the STA, and there is a third communication link between the first AP and the second AP.

It should be further noted that, the first communication link and the second communication link may be used for communication by using an 802.11 wireless air interface, and the third communication link may be used for communication by using an 802.11 wireless air interface or a wired DS.

It should be further noted that S101 and S103 are data transmission processes by using the first communication link, and S102 and S104 are data transmission processes by using the third communication link. An execution sequence of the data transmission processes by using the two communication links is not limited in embodiments of this application.

It should be further noted that S101 and S102 are processes in which the first AP generates data frames transmitted by using different communication links, and an execution sequence of the two steps is not limited in embodiments of this application. S103 and S104 are processes in which the first AP sends data frames by using different communication links, and an execution sequence of the two steps is not limited in embodiments of this application.

In other words, the first AP, namely, the primary AP, receives a plurality of MSDUs of a same TID from an upper layer, allocates a sequence number to each MSDU based on a receiving sequence of the plurality of MSDUs, encapsulates each MSDU, the sequence number of each MSDU, and the TID of each MSDU into a data frame, and sends a plurality of data frames generated based on the plurality of MSDUs to the STA by separately using two communication links.

Because this application relates to data transmission by using the 802.11 wireless air interface and data transmission by using the wired DS, involved data frames mainly include an 802.11 MAC data frame and an Ethernet data frame.

The following separately describes the first data frame and the second data frame.

1. First Data Frame

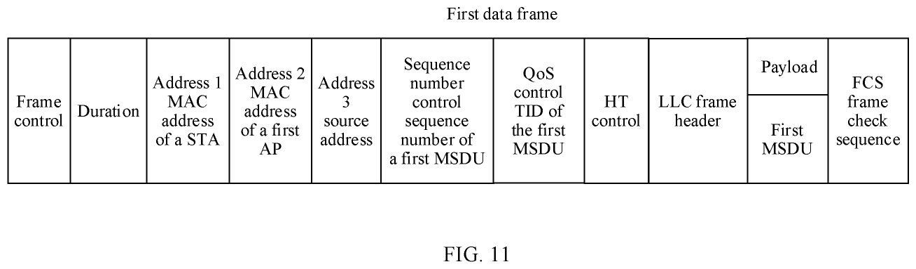

FIG. 11 is a possible frame format of the first data frame according to an embodiment of this application.

It should be noted that, because the first AP communicates with the STA by using the 802.11 wireless air interface, the first data frame may be a data frame of one-layer encapsulation. That is, a frame format of the 802.11 MAC data frame is used.

As shown in FIG. 11, some fields in the first data frame may be set as follows:

(1) An address 1 field is a MAC address of the STA.

(2) An address 2 field is a MAC address of the first AP.

(3) An address 3 field carries a destination MAC address of the first MSDU.

(4) A sequence number control field carries the sequence number of the first MSDU.

(5) A QoS control field carries the TID of the first MSDU.

(6) A frame body (frame body) includes an LLC frame header and a payload field:
An Ethertype field in the LLC frame header carries first Ethertype information, where a value of the first Ethertype information is “0x0800”.
A payload field carries the first MSDU.

It should be noted that, the fields in the first data frame directly sent by the first AP to the STA may be set based on the conventional technology.

2. Second Data Frame

It should be noted that, the second data frame includes the third data frame, and the third data frame carries the second MSDU, the sequence number of the second MSDU, and the TID of the second MSDU.

Optionally, the third data frame further carries a first receive address, a first transmit address, a source address, and first Ethertype information, the first receive address is a MAC address of a service access point SAP of a multi-link entity to which the STA belongs, the first transmit address is a MAC address of a SAP of a multi-link entity to which the first AP belongs, the source address is a MAC address of a source end of the second MSDU, and the first Ethertype information indicates to process payload by using an IP protocol.

To be specific, the second data frame may be in a frame format of two-layer encapsulation. A frame format of the 802.11 MAC data frame is used for the inner-layer third data frame, and payload of the third data frame carries the second MSDU, the sequence number of the second MSDU, and the TID of the second MSDU.

Optionally, the frame format of two-layer encapsulation of the second data frame may be in a plurality of forms. This is not limited in embodiments of this application.

The following describes in detail four possible frame formats of the second data frame provided in embodiments of this application.

It should be noted that, when the first AP communicates with the second AP by using the wired DS, the second data frame may be a two-layer encapsulated data frame. A frame format of the Ethernet data frame is used for an outer layer, and a frame format of the 802.11 MAC data frame is used for an inner layer.

It should be further noted that, when the first AP communicates with the second AP by using the 802.11 wireless air interface or a WDS (wireless DS), the second data frame may be a two-layer encapsulated data frame. A frame format of the 802.11 MAC data frame is used for an outer layer, and a frame format of the 802.11 MAC data frame is also used for an inner layer.

In a possible implementation, the second data frame further carries a second receive address, a second transmit address, second Ethertype information, and first payload type information, the second receive address is a MAC address of the second AP, the second transmit address is a MAC address of the first AP, the second Ethertype information indicates to process the first payload type information and the payload by using the 802.11 MAC protocol, and the first payload type information indicates that the payload includes a data frame used for multi-link aggregation.

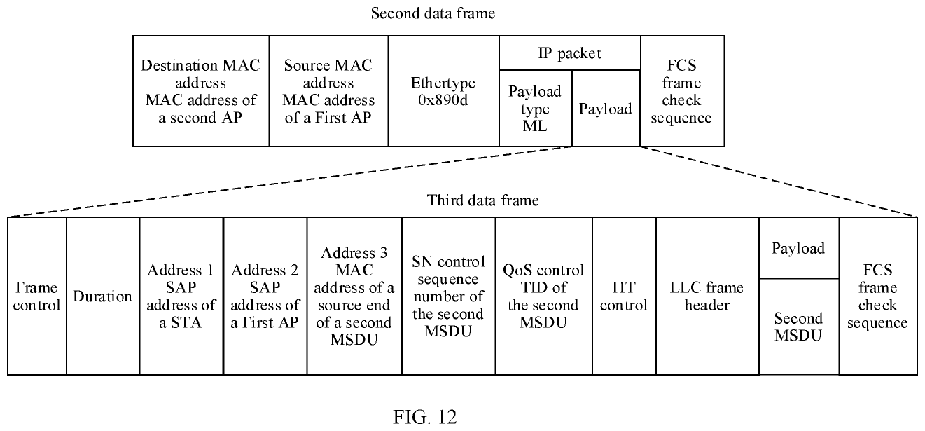

FIG. 12 is a first possible frame format of the second data frame according to an embodiment of this application. A frame format of the Ethernet data frame is used for an outer layer of the second data frame.

As shown in FIG. 12, some fields in the third data frame may be set as follows:

(1) An address 1 field carries the first receive address, namely, the MAC address of the SAP of the multi-link entity to which the STA belongs.

(2) An address 2 field carries the first transmit address, namely, the MAC address of the SAP of the multi-link entity to which the first AP belongs.

(3) An address 3 field carries the source address, namely, the MAC address of the source end of the second MSDU.

(4) An SN control field carries the sequence number of the second MSDU.

(5) A QoS control field carries the TID of the second MSDU.

(6) A frame body field includes an LLC frame header and a payload field:
An Ethertype field in the LLC frame header carries first Ethertype information, where a value of the first Ethertype information is “0x0800”.
A payload field carries the second MSDU.

According to the data transmission method provided in embodiments of this application, in packet-level and non-collocated scenarios, all AP interfaces on an AP side on which multi-link aggregation is performed share one SAP MAC address, and all STA interfaces on a STA side share another SAP MAC address, so that a same frame header address may be used for MSDUs transmitted by using different communication links, that is, there is no need to separately generate frame headers for the MSDUs on different communication links. This improves transmission efficiency.

As shown in FIG. 12, some fields in the second data frame may be set as follows:

(1) A destination MAC address field carries the second receive address, namely, the MAC address of the second AP.

(2) A source MAC address field carries the second transmit address, namely, the MAC address of the first AP.

(3) An Ethertype field carries second Ethertype information, where a value of the second Ethertype information is “0x890d”.

(4) A payload type field carries first payload type information, where a value of the first payload type information is “ML”.

(5) A payload field carries the third data frame.

FIG. 13 is a second possible frame format of the second data frame according to an embodiment of this application. A frame format of the 802.11 MAC data frame is used for an outer layer of the second data frame.

It should be noted that, for a frame format of an inner-layer third data frame in FIG. 13, refer to the frame format of the inner-layer third data frame in FIG. 12. To avoid repetition, details are not described herein again.

As shown in FIG. 13, some fields in the second data frame may be set as follows:

(1) An address 1 field carries the second receive address, namely, the MAC address of the second AP.

(2) An address 2 field carries the second transmit address, namely, the MAC address of the first AP.

(3) An address 3 field carries the source address, namely, the MAC address of the source end of the second MSDU.

(4) An SN control field carries a sequence number 2, namely, an SN maintained by the second AP.

(5) An address 4 field carries a destination address, namely, a MAC address of a destination end of the second MSDU.

(6) A QoS control field carries a TID 2, namely, a TID maintained by the second AP.

(7) An Ethertype field.

(8) A frame body includes an LLC frame header and a payload field:
An Ethertype field in the LLC frame header carries second Ethertype information, where a value of the second Ethertype information is “0x890d”.
A payload type field in the LLC frame header carries first payload type information, where a value of the first payload type information is “ML”.
A payload field carries the third data frame.

Optionally, as shown in FIG. 13, information carried in the SN control field and the QoS control field that are included in a frame header of an outer-layer 802.11 MAC data frame may be the same as or different from information carried in the SN control field and the QoS control field that are included in a frame header of an inner-layer 802.11 MAC data frame. This is not limited in embodiments of this application.

In a possible implementation, in FIG. 13, the SN control field in the outer layer may carry a sequence number (sequence number 2) that is of the second MSDU and that is in at least one MSDU sent by the first AP to the second AP, and the QoS control field may carry a TID (TID 2) of the second MSDU on the second AP.

In another possible implementation, the second data frame further carries a second receive address, a second transmit address, second Ethertype information, and first payload type information, the second receive address is a SAP address of the STA, the second transmit address is a MAC address of the first AP, the second Ethertype information indicates to process the first payload type information and the payload by using the 802.11 MAC protocol, and the first payload type information indicates that the payload includes a data frame used for multi-link aggregation.

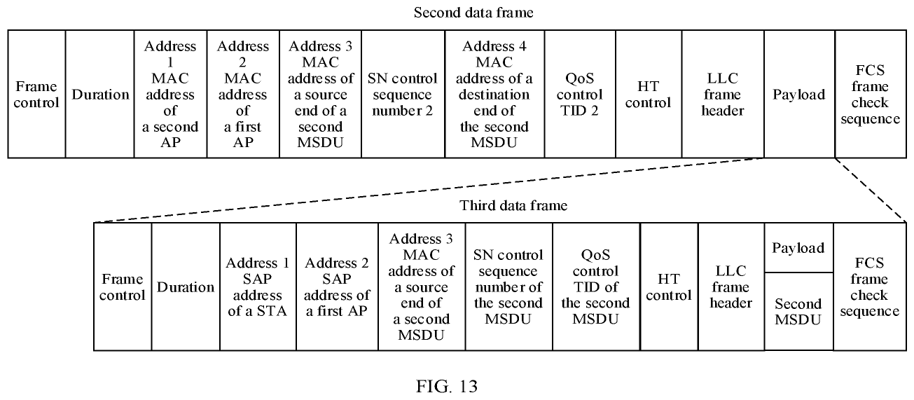

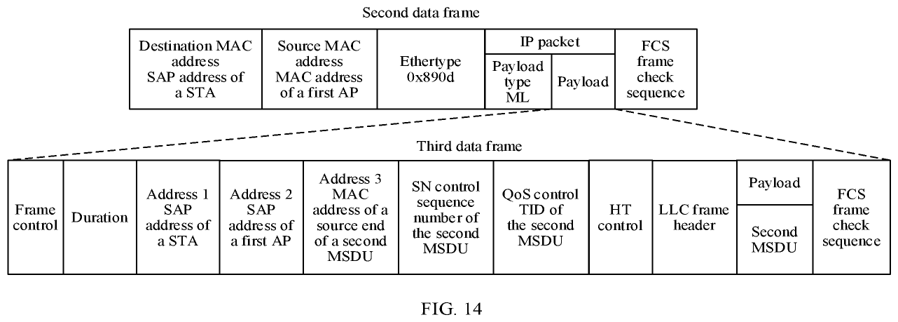

FIG. 14 is a third possible frame format of the second data frame according to an embodiment of this application. A frame format of the Ethernet data frame is used for an outer layer of the second data frame.

It should be noted that, for a frame format of an inner-layer third data frame in FIG. 14, refer to the frame format of the inner-layer third data frame in FIG. 12. To avoid repetition, details are not described herein again.

It should be further noted that a difference between a frame header of an outer layer in FIG. 14 and the frame header of the outer layer in FIG. 12 is setting of the following fields.

(1) A destination MAC address field carries a second receive address, namely, the MAC address of the SAP of the multi-link entity to which the STA belongs.

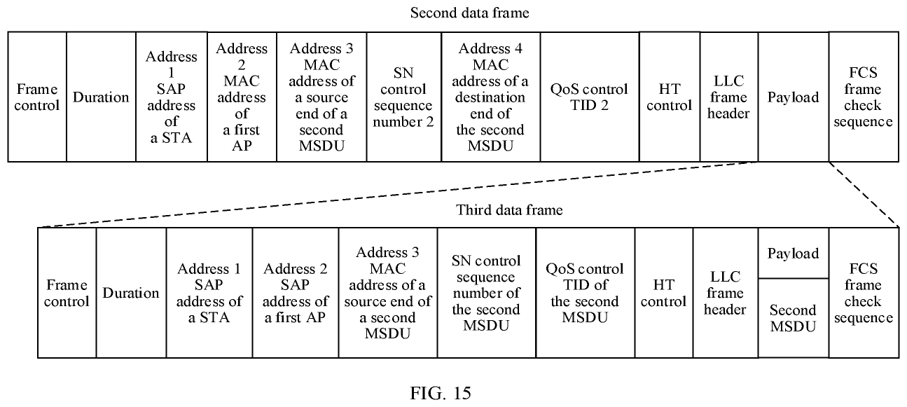

FIG. 15 is a fourth possible frame format of the second data frame according to an embodiment of this application. A frame format of the 802.11 MAC data frame is used for an outer layer of the second data frame.

It should be noted that, for a frame format of an inner-layer third data frame in FIG. 15, refer to the frame format of the inner-layer third data frame in FIG. 12. To avoid repetition, details are not described herein again.

It should be further noted that a difference between a frame header of an outer layer in FIG. 15 and the frame header of the outer layer in FIG. 13 is setting of the following fields.

(1) An address 1 field carries a second receive address, namely, the MAC address of the SAP of the multi-link entity to which the STA belongs.

S105: The second AP generates a fourth data frame based on the second MSDU, the sequence number of the second MSDU, and the TID of the second MSDU, where the fourth data frame carries the second MSDU, the sequence number of the second MSDU, and the TID of the second MSDU.

Optionally, a frame format of one-layer encapsulation (that is, the second AP performs non-transparent transmission) or two-layer encapsulation (that is, the second AP performs transparent transmission) may be used for the fourth data frame. This is not limited in embodiments of this application.

It should be noted that, because the second AP and the STA communicate with each other by using the 802.11 wireless air interface, the fourth data frame may be a one-layer encapsulated data frame, that is, a frame format of a one-layer 802.11 MAC data frame is used. Alternatively, the fourth data frame may be a two-layer encapsulated data frame, that is, a frame format of the 802.11 MAC data frame is used at both of an outer layer and an inner layer. This is not limited in embodiments of this application.

The following separately describes the frame format of the one-layer encapsulated fourth data frame and the frame format of the two-layer encapsulated fourth data frame.

In a possible implementation, when the fourth data frame is in the frame format of one-layer encapsulation, the second AP may generate the fourth data frame based on the second MSDU, the sequence number of the second MSDU, the TID of the second MSDU, the second receive address, the second Ethertype information, and the first payload type information.

It should be noted that the second AP may generate the one-layer encapsulated fourth data frame based on the first or second possible frame format of the second data frame.

In other words, after receiving the second data frame, the second AP learns, at a logical link control (logical link control, LLC) layer based on a second receive address field (the MAC address of the second AP) in the second data frame, that a receive end is the second AP; and further determines, based on an Ethertype field (whose value is “0x890d”), to process a payload type field and a payload field by using the 802.11 MAC protocol.

Correspondingly, the second AP generates, at an 802.11 MAC layer, the fourth data frame based on the payload type field (whose value is “ML”, that is, the payload includes the data frame used for multi-link aggregation) and a payload field (the third data frame) of the second data frame. The fourth data frame carries the second MSDU, the sequence number of the second MSDU, and the TID of the second MSDU that are carried in the third data frame.

Optionally, the fourth data frame further carries a third receive address, a third transmit address, the source address, and the first Ethertype information. The third receive address is a MAC address of the STA, and the third transmit address is the MAC address of the second AP.

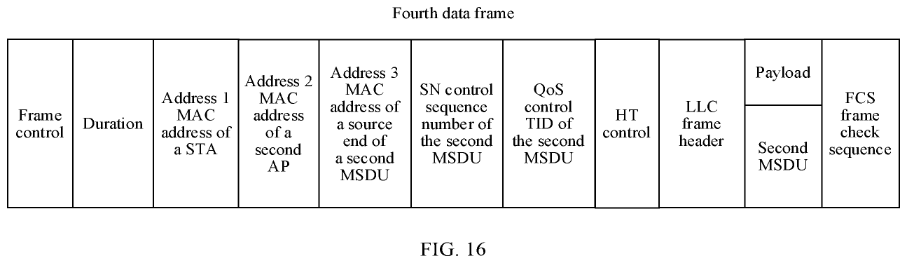

FIG. 16 is a first possible frame format of the fourth data frame according to an embodiment of this application. The frame format of the data frame is a frame format of one-layer encapsulation.

As shown in FIG. 16, some fields in the fourth data frame may be set as follows:

(1) An address 1 field carries a third receive address, namely, a MAC address of the STA.

(2) An address 2 field carries a third transmit address, namely, a MAC address of the second AP.

(3) An address 3 field carries the source address, namely, the MAC address of the source end of the second MSDU.

(4) An SN control field carries the sequence number of the second MSDU.

(5) A QoS control field carries the TID of the second MSDU.

(6) A frame body includes an LLC frame header and a payload field:
An Ethertype field in the LLC frame header carries first Ethertype information, where a value of the first Ethertype information is “0x0800”.
A payload field carries the second MSDU.

In another possible implementation, when the fourth data frame is in the frame format of two-layer encapsulation, the second AP may generate the fourth data frame based on the second MSDU, the sequence number of the second MSDU, the TID of the second MSDU, the second receive address, the second Ethertype information, and the first payload type information. The fourth data frame includes the third data frame, the second Ethertype information, and the first payload type information.

It should be noted that the second AP may generate the two-layer encapsulated fourth data frame based on the third or fourth possible frame format of the second data frame.

In other words, after receiving the second data frame, the second AP learns, at an LLC layer based on a second receive address field (the MAC address of the SAP of the multi-link entity to which the STA belongs) in the second data frame, that a receive end is not the second AP, and determines to directly forward a payload field in the second data frame, that is, generates the fourth data frame. The fourth data frame includes the third data frame, the second Ethertype information, and the first payload type information.

Optionally, the fourth data frame further carries a third receive address and a third transmit address. The third receive address is a MAC address of the STA, and the third transmit address is the MAC address of the second AP.

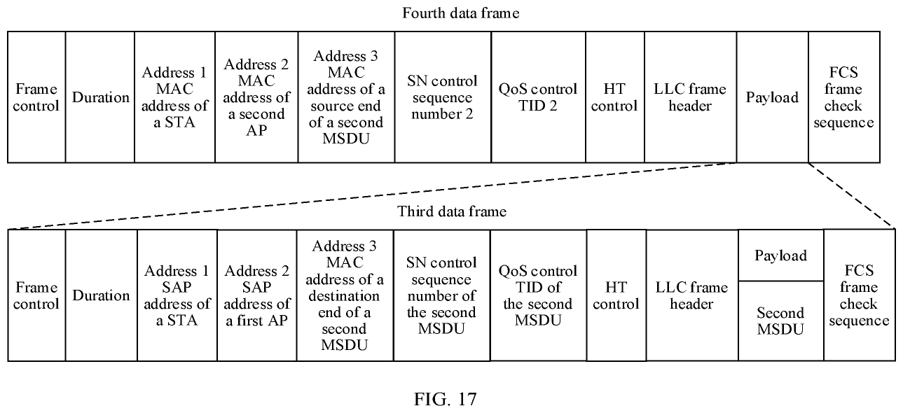

FIG. 17 is a second possible frame format of the fourth data frame according to an embodiment of this application. The frame format of the data frame is a frame format of two-layer encapsulation.

As shown in FIG. 17, some fields in the fourth data frame may be set as follows:

(1) An address 1 field carries a third receive address, namely, a MAC address of the STA.

(2) An address 2 field carries a third transmit address, namely, a MAC address of the second AP.

(3) An address 3 field carries the source address, namely, the MAC address of the source end of the second MSDU.

(4) An SN control field carries a sequence number 2.

(5) A QoS control field carries a TID 2.

(6) A frame body includes an LLC frame header and a payload field:
An Ethertype field in the LLC frame header carries second Ethertype information, where a value of the second Ethertype information is “0x890d”.
A payload type field in the LLC frame header carries first payload type information, where a value of the first payload type information is “ML”.
A payload field carries the third data frame.

It should be noted that, for a frame format of an inner-layer third data frame in FIG. 17, refer to the frame format of the inner-layer third data frame in FIG. 12. To avoid repetition, details are not described herein again.

S106: The second AP sends the fourth data frame to the STA, and correspondingly, the STA receives the fourth data frame sent by the second AP.

Optionally, after S106, the method 100 may further include S107 to S109.

S107: The STA obtains the first MSDU, the TID of the first MSDU, and the sequence number of the first MSDU based on the first data frame.

S108: The STA obtains the second MSDU, the TID of the second MSDU, and the sequence number of the second MSDU based on the fourth data frame.

It should be noted that, in a case in which the first data frame and the fourth data frame are of one-layer encapsulation, the STA may perform processing according to an existing protocol.

It should be further noted that, for a case in which the fourth data frame is of two-layer encapsulation, the STA removes a frame header of the 802.11 MAC data frame at the 802.11 MAC layer, and then delivers the fourth data frame to the LLC layer. The LLC layer finds that the third receive address is the LLC layer and the value of the Ethertype field is “0x890d”. Then, the STA re-delivers the fourth data frame to the 802.11 MAC layer to perform inner-layer decapsulation, and delivers a decapsulated fourth data frame to the LLC layer. In this case, the LLC layer finds that the destination address is the LLC layer and the value of the Ethertype field is “0x0800”, and then delivers the fourth data frame to an IP layer for processing according to the existing protocol.

It should be further noted that S101, S103, and S107 are a process in which the first AP generates the first data frame and transmits the first data frame to the STA in a downlink manner by using the first communication link. S102, S104, S106, and S108 are a process in which the first AP generates the second data frame and transmits the second data frame to the STA in the downlink manner by using the third communication link and the second communication link. An execution sequence of the two processes is not limited in embodiments of this application.

S109: The STA adds the first MSDU and the second MSDU to a receive queue based on the TID of the second MSDU, the sequence number of the second MSDU, the TID of the first MSDU, and the sequence number of the first MSDU.

Optionally, the STA may further receive another MSDU, a sequence number of the another MSDU, and a TID of the another MSDU that are sent by the first AP by using the first communication link or the second communication link. The TID of the another MSDU is the same as the TID of the first MSDU and the TID of the second MSDU. This is not limited in embodiments of this application.

It should be noted that, after the STA adds all received plurality of MSDUs to the receive queue, the STA may obtain complete data streams belonging to a same TID.

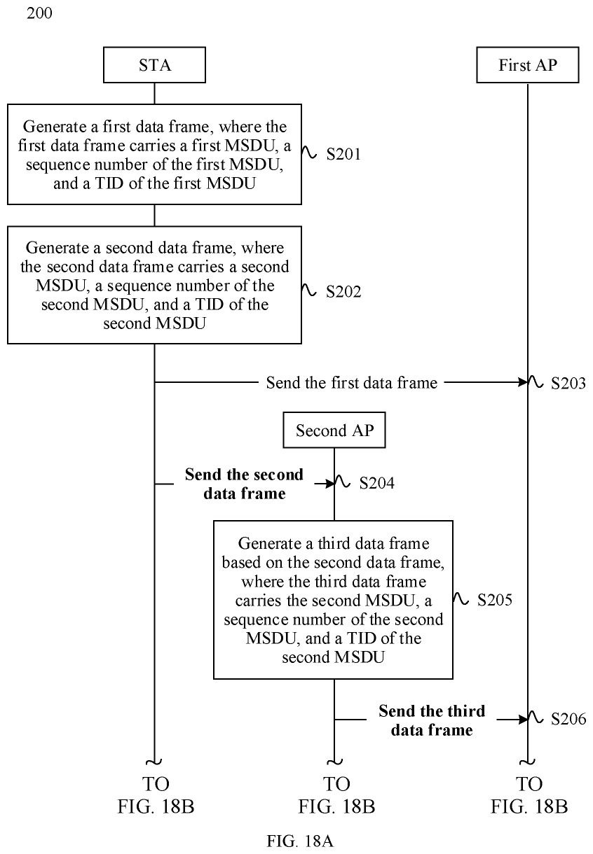

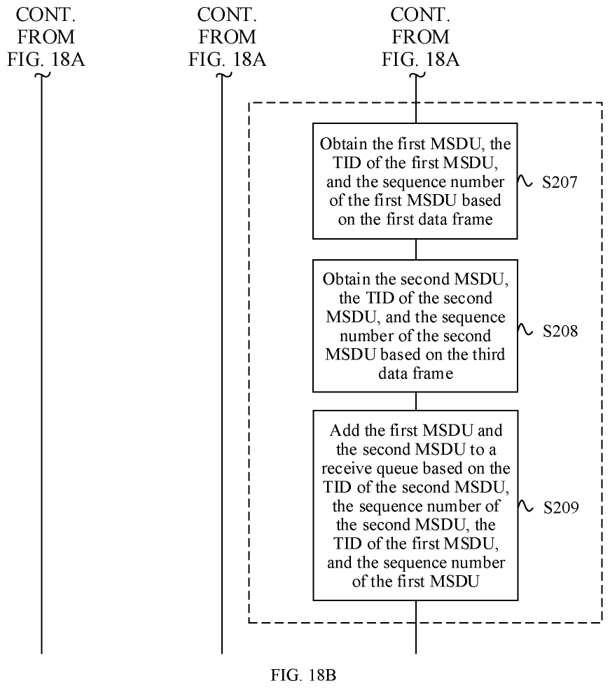

FIG. 18A and FIG. 18B are a schematic flowchart of a data transmission method 200 according to an embodiment of this application. The method 200 may be applicable to packet-level and non-collocated multi-link aggregation uplink transmission scenarios.

S201: A STA generates a first data frame, where the first data frame carries a first media access control service data unit MSDU, a sequence number of the first MSDU, and a traffic identifier TID of the first MSDU.

S202: The STA generates a second data frame, where the second data frame carries a second MSDU, a sequence number of the second MSDU, and a TID of the second MSDU, the TID of the first MSDU is the same as the TID of the second MSDU, and the sequence number of the first MSDU and the sequence number of the second MSDU are allocated based on an obtaining sequence.

S203: The STA sends the first data frame to a first AP, and correspondingly, the first AP receives the first data frame sent by the STA.

S204: The STA sends the second data frame to a second AP, and correspondingly, the second AP receives the second data frame sent by the STA.

It should be noted that, in a multi-link aggregation process, the first AP is a primary AP, and the second AP is a secondary AP. There is a first communication link between the first AP and the STA, there is a second communication link between the first AP and the STA, and there is a third communication link between the first AP and the second AP.

It should be further noted that, the first communication link and the second communication link may be used for communication by using an 802.11 wireless air interface, and the third communication link may be used for communication by using an 802.11 wireless air interface or a wired DS.

It should be further noted that S201 and S203 are data transmission processes by using the first communication link, and S202 and S204 are data transmission processes by using the second communication link. An execution sequence of the data transmission processes by using the two communication links is not limited in embodiments of this application.

It should be further noted that S201 and S202 are processes in which the STA generates different data frames, and an execution sequence of the two steps is not limited in embodiments of this application. S203 and S204 are processes in which the STA sends data frames by using different communication links, and an execution sequence of the two steps is not limited in embodiments of this application.

In other words, the STA receives a plurality of MSDUs of a same TID from an upper layer, allocates a sequence number to each MSDU based on a receiving sequence of the plurality of MSDUs, encapsulates each MSDU, the sequence number of each MSDU, and the TID of each MSDU into a data frame, and sends a plurality of data frames generated based on the plurality of MSDUs to the first AP by separately using two communication links.

Because this application relates to data transmission by using the 802.11 wireless air interface and data transmission by using the wired DS, involved data frames mainly include an 802.11 MAC data frame and an Ethernet data frame.

The following separately describes the first data frame and the second data frame.

1. First Data Frame

FIG. 19 is a possible frame format of the first data frame according to an embodiment of this application.

It should be noted that, because the first AP may communicate with the STA by using the 802.11 wireless air interface, the first data frame may be a data frame of one-layer encapsulation. That is, a frame format of the 802.11 MAC data frame is used.

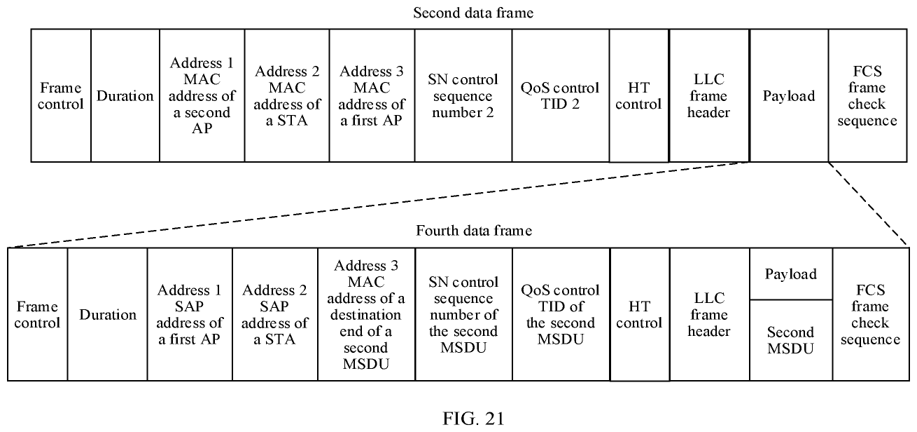

As shown in FIG. 21, some fields in the first data frame may be set as follows:

(1) An address 1 field is a MAC address of the first AP.

(2) An address 2 field is a MAC address of the STA.

(3) An address 3 field carries a destination MAC address of the first MSDU.

(4) A sequence number control field carries the sequence number of the first MSDU.

(5) A QoS control field carries the TID of the first MSDU.

(6) A frame body includes an LLC frame header field and a payload field:
An Ethertype field in the LLC frame header carries first Ethertype information, where a value of the first Ethertype information is “0x0800”.
A payload field carries the first MSDU.

It should be noted that, the fields in the first data frame directly sent by the STA to the first AP may be set based on the conventional technology.

2. Second Data Frame

Optionally, the second data frame may be a one-layer encapsulated data frame, that is, a frame format of a one-layer 802.11 MAC data frame is used. Alternatively, the second data frame may be a two-layer encapsulated data frame, that is, a frame format of a two-layer 802.11 MAC data frame is used. This is not limited in embodiments of this application.

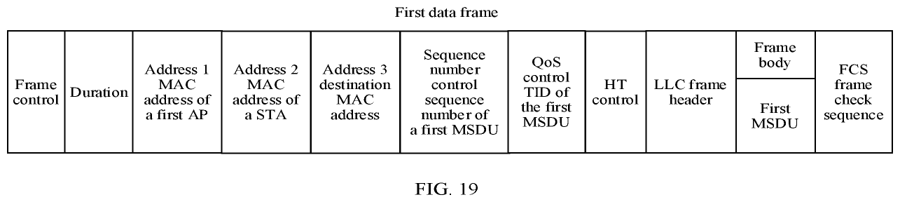

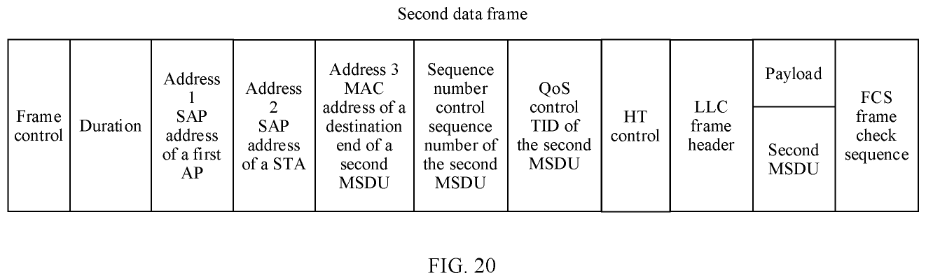

FIG. 20 is a first possible frame format of the second data frame according to an embodiment of this application. The frame format of the second data frame is a frame format of one-layer encapsulation.

Optionally, the second data frame carries the second MSDU, the sequence number of the second MSDU, the TID of the second MSDU, a first receive address, a first transmit address, a first destination address, and first Ethertype information, the first receive address is a MAC address of a SAP of a multi-link entity to which the first AP belongs, the first transmit address is a MAC address of a SAP of a multi-link entity to which the STA belongs, the first destination address is a MAC address of a destination end of the second MSDU, and the first Ethertype information indicates to process payload by using an IP protocol.

As shown in FIG. 20, some fields in the second data frame may be set as follows:

(1) An address 1 field carries the first receive address, namely, the MAC address of the SAP of the multi-link entity to which the first AP belongs.

(2) An address 2 field carries the first transmit address, namely, the MAC address of the SAP of the multi-link entity to which the STA belongs.

(3) An address 3 field carries the first destination address, namely, the MAC address of the destination end of the second MSDU.

(4) A sequence number control field carries the sequence number of the second MSDU.

(5) A QoS control field carries the TID of the second MSDU.

(6) A frame body includes an LLC frame header and a payload field:
An Ethertype field in the LLC frame header carries first Ethertype information, where a value of the first Ethertype information is “0x0800”.
A payload field carries the second MSDU.

FIG. 21 is a second possible frame format of the second data frame according to an embodiment of this application. The frame format of the second data frame is a frame format of two-layer encapsulation.

As shown in FIG. 21, the second data frame includes a fourth data frame. The fourth data frame carries the second MSDU, the sequence number of the second MSDU, the TID of the second MSDU, a first receive address, a first transmit address, a first destination address, and first Ethertype information, the first receive address is a MAC address of a service access point SAP of a multi-link entity to which the first AP belongs, the first transmit address is a MAC address of a SAP of a multi-link entity to which the STA belongs, the first destination address is a MAC address of a destination end of the second MSDU, and the first Ethertype information indicates to process payload by using an IP protocol.

Optionally, the second data frame further carries a second receive address, a second transmit address, a second destination address, second Ethertype information, and first payload type information, the second receive address is a MAC address of the second AP, the second transmit address is a MAC address of the STA, the second destination address is a MAC address of the first AP or the MAC address of the SAP of the multi-link entity to which the first AP belongs, the second Ethertype information indicates to process the first payload type information and the payload by using the 802.11 MAC protocol, and the first payload type information indicates that the payload includes a data frame used for multi-link aggregation.

As shown in FIG. 21, some fields in the second data frame may be set as follows:

(1) An address 1 field carries the second receive address, namely, the MAC address of the second AP.

(2) An address 2 field carries the second transmit address, namely, the MAC address of the STA.

(3) An address 3 field carries the second destination address, namely, the MAC address of the first AP or the MAC address of the SAP of the multi-link entity to which the first AP belongs.

(4) A sequence number control field carries the sequence number of the second MSDU.

(5) A QoS control field carries the TID of the second MSDU.

(6) A frame body includes an LLC frame header and a payload field:
An Ethertype field in the LLC frame header carries second Ethertype information, where a value of the second Ethertype information is “0x890d”.
A payload type field in the LLC frame header carries first payload type information, where a value of the first payload type information is “ML”.
A payload field carries the third data frame.

It should be noted that, for a frame format of an inner-layer fourth data frame in the two-layer encapsulated second data frame in FIG. 21, refer to the frame format of the one-layer encapsulated second data frame in FIG. 20. To avoid repetition, details are not described herein again.

S205: The second AP generates a third data frame based on the second MSDU, the sequence number of the second MSDU, and the TID of the second MSDU, where the third data frame carries the second MSDU, the sequence number of the second MSDU, and the TID of the second MSDU.

It should be noted that, because the first AP may communicate with the second AP by using a wired DS, the fourth data frame may be a two-layer encapsulated data frame. A frame format of the Ethernet data frame is used for an outer layer, and a frame format of the 802.11 MAC data frame is used for an inner layer.

In a possible implementation, when the second data frame is in a frame format of one-layer encapsulation, the second AP may generate the third data frame based on the second MSDU, the sequence number of the second MSDU, the TID of the second MSDU, and the first receive address. The third data frame includes the second data frame.

In other words, after receiving the second data frame, the second AP learns, at an LLC layer based on the first receive address (the MAC address of the SAP of the multi-link entity to which the first AP belongs) in the second data frame, that a receive end is not the second AP, and directly forwards payload that is of the second data frame and that is carried in the third data frame.

Optionally, the third data frame further carries a second receive address, a second transmit address, second Ethertype information, and first payload type information, the second receive address is the MAC address of the first AP, the second transmit address is the MAC address of the second AP, the second Ethertype information indicates to process the first payload type information and the payload by using the 802.11 MAC protocol, and the first payload type information indicates that the payload includes a data frame used for multi-link aggregation.

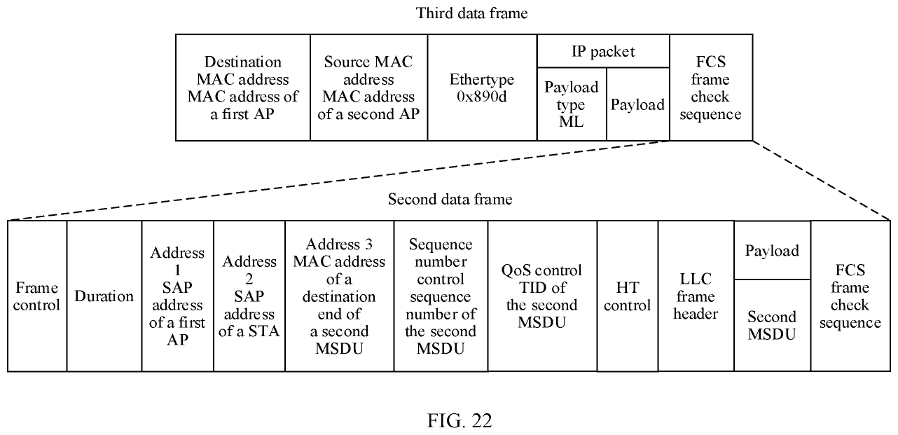

As shown in FIG. 22, some fields in the third data frame may be set as follows:

(1) A destination MAC address field carries the second receive address, namely, the MAC address of the first AP.

(2) A source MAC address field carries the second transmit address, namely, the MAC address of the second AP.

(3) An Ethertype field carries second Ethertype information, where a value of the second Ethertype information is “0x890d”.

(4) A payload type field carries first payload type information, where a value of the first payload type information is “ML”.

(5) A payload field carries the second data frame.

It should be noted that, for a frame format of an inner-layer second data frame in the two-layer encapsulated third data frame in FIG. 22, refer to the frame format of the one-layer encapsulated second data frame in FIG. 20. To avoid repetition, details are not described herein again.

In another possible implementation, when the second data frame is in the frame format of two-layer encapsulation, the second AP may generate the third data frame based on the second MSDU, the sequence number of the second MSDU, the TID of the second MSDU, the second receive address, the second destination address, the second Ethertype information, and the first payload type information. The third data frame includes the fourth data frame, the second Ethertype information, and the first payload type information.

In other words, after receiving the second data frame, the second AP learns, at an LLC layer based on the second receive address (the MAC address of the second AP) and the second destination address (the MAC address of the first AP) that are in the second data frame, that a receive end is the second AP but a destination end is not the second AP, and directly forwards payload that is of the fourth data frame included in the second data frame and that is carried in the third data frame.

Optionally, the third data frame further carries a third receive address and a third transmit address. The third receive address is the MAC address of the first AP, and the third transmit address is the MAC address of the second AP.

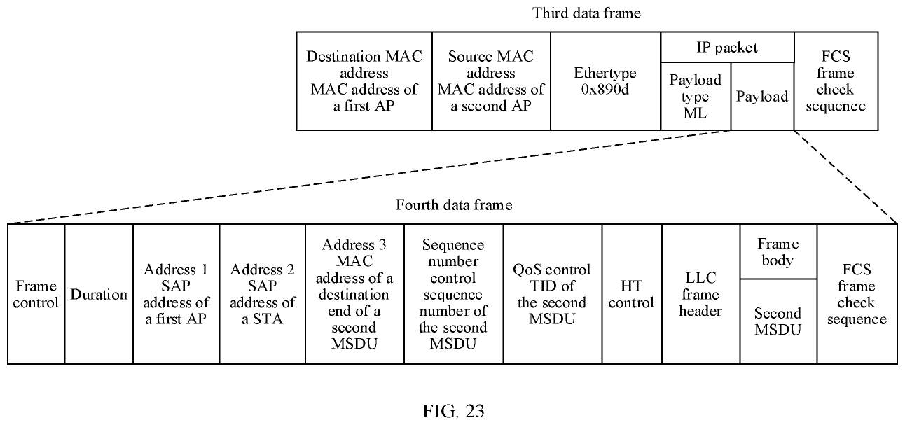

It should be noted that, for a frame format of an outer layer of the two-layer encapsulated third data frame in FIG. 23, refer to a frame format of an outer layer of the two-layer encapsulated third frame format in FIG. 22. For a frame format of the inner-layer second data frame in the two-layer encapsulated third data frame in FIG. 23, refer to a frame format of the inner-layer fourth data frame in the two-layer encapsulated second data frame in FIG. 21. To avoid repetition, details are not described herein again.

S206: The second AP sends the third data frame to the first AP, and correspondingly, the first AP receives the third data frame sent by the second AP.

Optionally, after S206, the method 200 may further include S207 to S209.

S207: The first AP obtains the first MSDU, the TID of the first MSDU, and the sequence number of the first MSDU based on the first data frame.

S208: The first AP obtains the second MSDU, the TID of the second MSDU, and the sequence number of the second MSDU based on the third data frame.

It should be noted that, the first AP may decapsulate the first data frame according to an existing protocol.

It should be further noted that, for the two-layer encapsulated third data frame, the second AP delivers, based on that a destination address of a destination address field in the frame format of the outer layer is set to the second AP and an Ethertype field is set to “0x890d”, a payload type field and a payload field to an 802.11 MAC layer for processing. The 802.11 layer removes an 802.11 MAC header from the frame format of the inner layer, and sends the frame to the LLC layer. In this case, the LLC layer finds that the destination address is not the LLC layer and Ethertype is 0x0800, and then the LLC layer sends the frame to an IP layer for processing according to an existing protocol.

S209: The first AP adds the first MSDU and the second MSDU to a receive queue based on the TID of the second MSDU, the sequence number of the second MSDU, the TID of the first MSDU, and the sequence number of the first MSDU.

Optionally, the first AP may further receive another MSDU, a sequence number of the another MSDU, and a TID of the another MSDU that are sent by the STA by using the first communication link or the second communication link. The TID of the another MSDU is the same as the TID of the first MSDU and the TID of the second MSDU. This is not limited in embodiments of this application.

It should be noted that, after the first AP adds all received plurality of MSDUs to the receive queue, the first AP may obtain complete data streams belonging to a same TID.

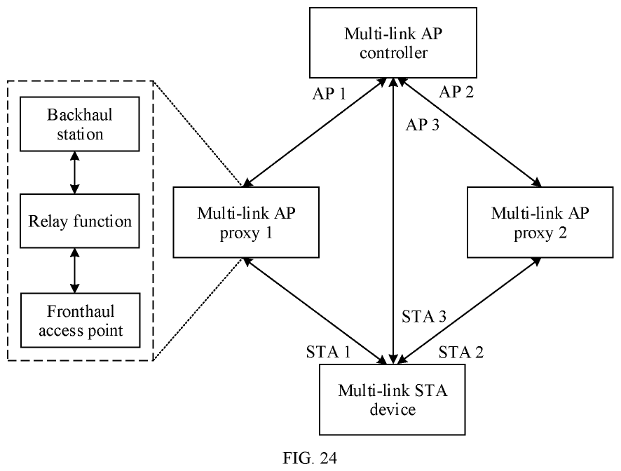

FIG. 24 is a collocated multi-link aggregation scenario with an AP proxy according to an embodiment of this application.

It should be noted that a multi-link AP controller (a multi-link AP device) includes a plurality of AP interfaces (for example, an AP 1, an AP 2, and an AP 3), a multi-link STA device includes a plurality of STA interfaces (for example, a STA 1, a STA 2, and a STA 3), and the multi-link AP controller is responsible for managing multi-link aggregation between the plurality of AP interfaces and the plurality of STA interfaces. There may be a multi-link AP proxy on some of a plurality of communication links established between the plurality of AP interfaces and the plurality of STA interfaces (for example, a communication link: the AP 1 to an AP proxy 1 to the STA 1, and a communication link: the AP 2 to an AP proxy 2 to the STA 2).

It should be further noted that the multi-link AP proxy mainly includes a backhaul station (backhaul STA) and a relay function (relay function) fronthaul access point (fronthaul AP). The backhaul station may be associated with an AP (interface) in the multi-link AP controller, and the fronthaul access point may be associated with a STA (interface) in the multi-link STA device.

It should be noted that FIG. 24 is only three communication links between the multi-link AP controller and the multi-link STA device. The AP 3 to the STA 3 is a direct communication link, and the AP 1 to the AP proxy 1 to the STA 1 and the AP 2 to the AP proxy 2 to the STA 2 are indirect communication links. However, this embodiment of this application is not limited thereto. There may be other quantities of direct links and indirect links between the multi-link AP controller and the multi-link STA device, multi-link aggregation can be performed provided that a total quantity of communication links is greater than 1. This is not limited in embodiments of this application.

Optionally, FIG. 24 is only one AP proxy included on an indirect link. However, this is not limited in embodiments of this application. There may be one or more AP proxies on each indirect link between the multi-link AP controller and the multi-link STA device. This is not limited in embodiments of this application.

In the scenario shown in FIG. 24, if wanting to perform packet-level multi-link aggregation with the multi-link STA device, the multi-link AP controller needs to first establish a packet-level multi-link aggregation communication link with the multi-link STA device. The following describes how the multi-link AP controller establishes the multi-link aggregation communication link with the multi-link STA.

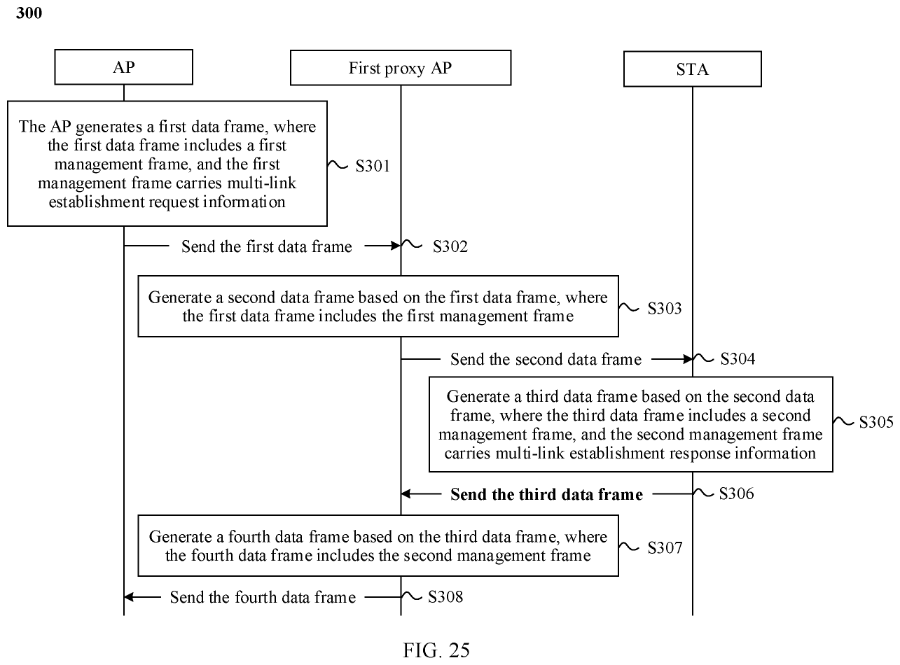

FIG. 25 is a schematic flowchart of a communication method 300 according to an embodiment of this application. The method 300 may be applied to a multi-AP downlink transmission scenario in collocated multi-link aggregation shown in FIG. 24.

S301: An AP generates a first data frame, where the first data frame includes a first management frame, the first management frame carries multi-link establishment request information, the multi-link establishment request information is used to request to establish a plurality of communication links to a STA, the plurality of communication links are used to transmit a plurality of MSDUs belonging to a same TID, and there is a proxy AP on at least one of the plurality of communication links.

S302: The AP sends the first data frame to a first proxy AP, where the at least one communication link includes a communication link to which the first proxy AP belongs; and correspondingly, the first proxy AP receives the first data frame sent by the AP.

S303: The first proxy AP determines a second data frame based on the first data frame, where the second data frame includes the first management frame.

S304: The first proxy AP sends the second data frame to the STA.

Optionally, the first management frame further carries a first receive address, a first transmit address, a source address, and first Ethertype information, the first receive address is a MAC address of a SAP of a multi-link entity to which the STA belongs, the second transmit address is a MAC address of a SAP of a multi-link entity to which the AP belongs, the source address is a MAC address of a source end of multi-link establishment request information, and the first Ethertype information indicates to process payload by using an IP protocol.

Optionally, the first data frame carries a second receive address, a second transmit address, the source address, a destination address, second Ethertype information, and first payload type information, the second receive address is a MAC address of a relay STA of the first proxy AP, the second transmit address is a MAC address of the AP, the destination address is a MAC address of the STA or the MAC address of the SAP of the multi-link entity to which the STA belongs, the second Ethertype information indicates to process the first payload type information and the payload by using the 802.11 protocol, and the first payload type information indicates that the payload includes a data frame used for multi-link aggregation.

It should be noted that the second data frame may be a two-layer encapsulated data frame, that is, a frame format of an 802.11 MAC data frame is used for an outer layer, and a frame format of an 802.11 MAC management frame (for example, an action frame in the management frame) is used for an inner layer. This is not limited in embodiments of this application.

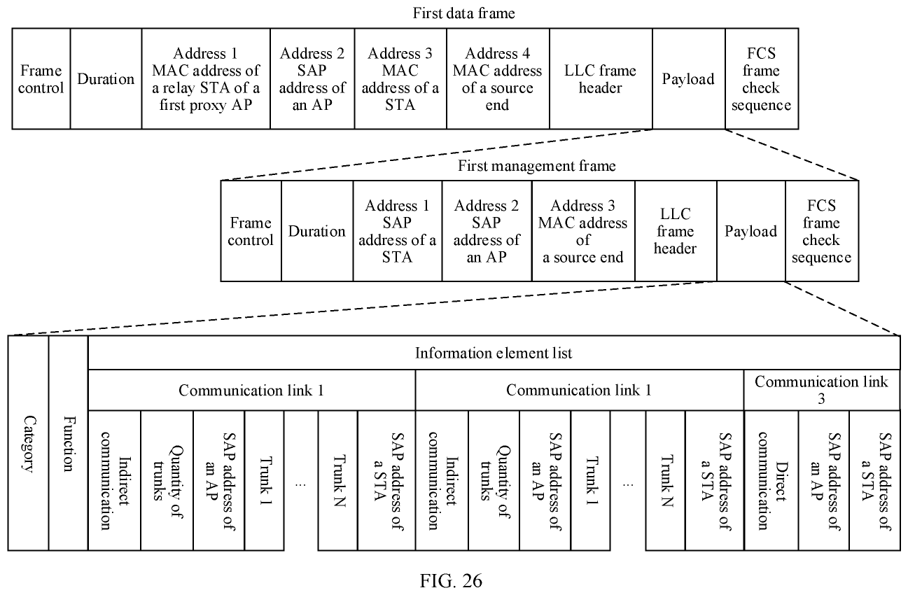

FIG. 26 is a possible frame format of the first data frame according to an embodiment of this application.

As shown in FIG. 26, some fields in the first management frame may be set as follows:

(1) An address 1 field carries the first receive address, namely, the MAC address of the SAP of the multi-link entity to which the STA belongs.

(2) An address 2 field carries the first transmit address, namely, the MAC address of the SAP of the multi-link entity to which the AP belongs.

(3) An address 3 field carries the source address, namely, the MAC address of the source end of the multi-link establishment request information.

(4) A frame body includes an LLC frame header and a payload field:
An Ethertype field in the LLC frame header carries first Ethertype information, where a value of the first Ethertype information is “0x0800”.
A payload field carries a type field, a function field, and an information element list field, where the information element list is used to store the multi-link establishment request information.

As shown in FIG. 26, some fields in the first data frame may be set as follows:

(1) An address 1 field carries the second receive address, namely, the MAC address of the relay STA of the first proxy AP.

(2) An address 2 field carries the second transmit address, namely, the MAC address of the AP.

(3) An address 3 field carries the destination address, namely, the MAC address of the STA or the MAC address of the SAP of the multi-link entity to which the STA belongs.

(4) An address 4 field carries the MAC address of the source end of the multi-link establishment request information.

(5) A frame body includes an LLC frame header and a payload field:
An Ethertype field in the LLC frame header carries second Ethertype information, where a value of the second Ethertype information is “0x890d”.
A payload type field in the LLC frame header carries first payload type information, where a value of the first payload type information is “ML”.
A payload field carries the first management frame.

Optionally, the first proxy AP may generate the second data frame based on the second receive address, the second Ethertype information, and the first payload type information.

In other words, after receiving the first data frame, the first proxy AP learns, at an LLC layer based on the second receive address (the MAC address of the relay STA of the first proxy AP) and the destination address (the MAC address of the STA or the MAC address of the SAP of the multi-link entity to which the STA belongs) that are in the first data frame, that a receive end is the first proxy AP but a destination end is not the first proxy AP; and directly adds the first management frame in the payload of the first data frame to the second data frame. The second data frame carries the second Ethertype information and the first payload type information.

The second data frame further carries a third receive address and a third transmit address. The third receive address is a MAC address of the STA, and the third transmit address is a MAC address of a relay AP of the first proxy AP.

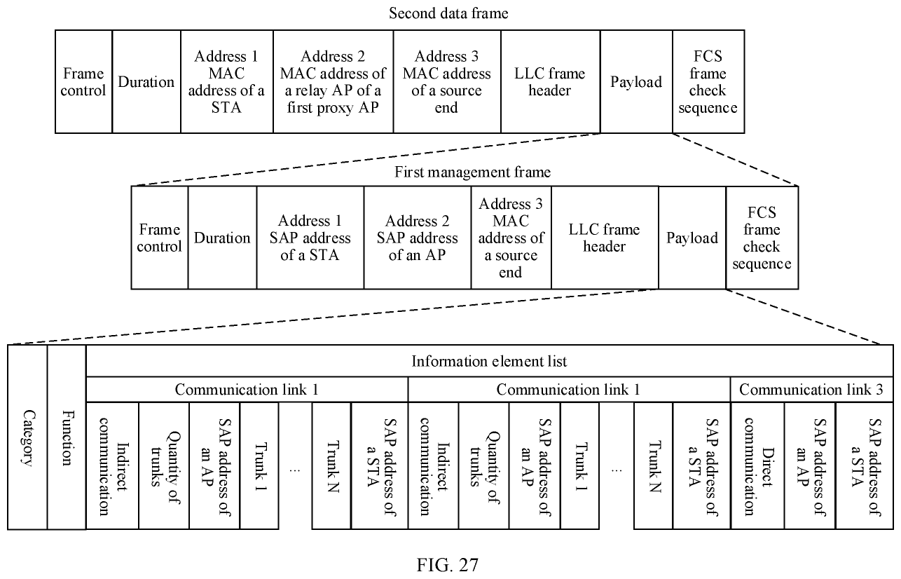

FIG. 27 is a possible frame format of the second data frame according to an embodiment of this application.

As shown in FIG. 27, some fields in the second data frame may be set as follows:

(1) An address 1 field carries the third receive address, namely, the MAC address of the STA.

(2) An address 2 field carries the third transmit address, namely, the MAC address of the relay AP of the first proxy AP.

(3) An address 3 field carries the MAC address of the source end of the multi-link establishment request information.

(4) A frame body includes an LLC frame header and a payload field:
An Ethertype field in the LLC frame header carries second Ethertype information, where a value of the second Ethertype information is “0x890d”.
A payload type field in the LLC frame header carries first payload type information, where a value of the first payload type information is “ML”.
A payload field carries the first management frame.

Optionally, the multi-link establishment request information may include at least one of the following three types of information. This is not limited in embodiments of this application.

First information: Link type information of each of the plurality of communication links indicates whether there is a proxy AP on each communication link.

Second information: When the plurality of communication links include a first communication link, and there is at least one proxy AP on the first communication link, the multi-link establishment request information further includes first link information, and the first link information includes the MAC address of the service access point SAP of the multi-link entity to which the AP belongs, the MAC address of the SAP of the multi-link entity to which the STA belongs, a quantity of the at least one proxy AP, a MAC address of a relay STA and a MAC address of a relay AP that are of each of the at least one proxy AP.

Third information: When the plurality of communication links include a second communication link, and there is no proxy AP on the second communication link, the multi-link establishment request information further includes second link information, and the second link information includes a MAC address of a first service access point to which the AP belongs and a MAC address of a second service access point to which the STA belongs.

It should be noted that FIG. 26 and FIG. 27 merely exemplarily show that the multi-link establishment request information includes information about three communication links. The multi-link request information may include information about all communication links in multi-link aggregation. This is not limited in embodiments of this application.

Optionally, FIG. 26 and FIG. 27 merely exemplarily show a possible setting manner of the information element list field that carries the multi-link establishment request information. Various information included in the multi-link establishment request information may alternatively be carried in the information element list field in another manner. This is not limited in embodiments of this application.

Optionally, after S304, the method may further include the following steps.

S305: The STA generates a third data frame based on the second data frame, where the third data frame includes a second management frame, the second management frame carries multi-link establishment response information, and the multi-link establishment response information is used to respond to establishment of the plurality of communication links to the AP.

S306: The STA sends the third data frame to the first proxy AP, and correspondingly, the first proxy AP receives the third data frame sent by the STA.

S307: The first proxy AP generates a fourth data frame based on the third data frame, where the fourth data frame includes the second management frame.

S308: The first proxy AP sends the fourth data frame to the AP, and correspondingly, the AP receives the fourth data frame sent by the first proxy AP.

Optionally, the multi-link establishment response information may include at least one of the foregoing three types of information.

It should be noted that a frame format of the third data frame is similar to the frame format of the first data frame, and a frame format of the fourth data frame is similar to the frame format of the second data frame. To avoid repetition, details are not described herein again.

Optionally, before S301, the STA reports, to a forwarding AP associated with the STA, capability information of the STA and related information of the multi-link STA device, for example, a MAC address of the multi-link STA device and a BSS ID of an AP associated with the multi-link STA device. The multi-link AP controller may send a client capability query message (Client Capability Query message) to request a multi-link AP proxy to report capability information of a STA associated with a forwarding AP of the multi-link AP proxy. After receiving the client capability query message, the multi-link AP proxy sends a client capability report message (Client Capability Report message) to the multi-link AP controller. The client capability report message indicates related information of each associated STA, for example, MAC addresses of all multi-link STAs, supported encryption algorithms, BSSIDs of associated APs, and whether the STA has a multi-link aggregation capability (including whether packet-level aggregation or flow-level aggregation is supported), where if the STA has the multi-link aggregation capability, further indication is required. Correspondingly, the multi-link AP controller may determine, based on the client capability report message sent by the multi-link AP proxy, that the multi-link STA device has the multi-link aggregation capability.

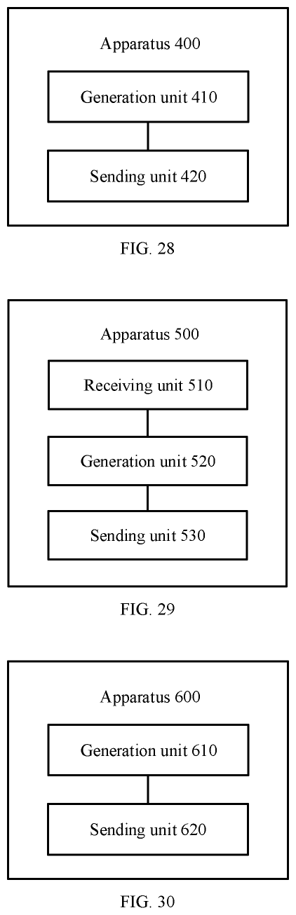

The foregoing describes in detail the data transmission method and the communication method provided in embodiments of this application with reference to FIG. 1 to FIG. 27. The following describes a data transmission apparatus and a communication apparatus provided in embodiments of this application with reference to FIG. 28 to FIG. 39.

FIG. 28 is a schematic block diagram of a data transmission apparatus 400 according to an embodiment of this application. The apparatus 400 includes: a generation unit 410, configured to generate a first data frame, where the first data frame carries a first MSDU in a plurality of MSDUs, a sequence number of the first MSDU, and a TID of the first MSDU, TIDs of the plurality of MSDUs are the same, a sequence number of each of the plurality of MSDUs is allocated based on an obtaining sequence, and the generation unit 410 is further configured to generate a second data frame, where the second data frame includes a third data frame, and the third data frame carries a second MSDU in the plurality of MSDUs, a sequence number of the second MSDU, and a TID of the second MSDU; and a sending unit 420, configured to send the first data frame to a STA, where the sending unit 420 is further configured to send the second data frame to a second AP.

In a possible implementation, the third data frame further carries a first receive address, a first transmit address, a destination address, and first Ethertype information, the first receive address is a MAC address of a service access point SAP of a multi-link entity to which the STA belongs, the first transmit address is a MAC address of a SAP of a multi-link entity to which the first AP belongs, the destination address is a MAC address of a destination end of the second MSDU, and the first Ethertype information indicates to process payload by using an IP protocol.

In a possible implementation, the second data frame further carries a second receive address, a second transmit address, second Ethertype information, and first payload type information, the second receive address is a MAC address of the second AP, the second transmit address is a MAC address of the first AP, the second Ethertype information indicates to process the first payload type information and the payload by using the 802.11 MAC protocol, and the first payload type information indicates that the payload includes a data frame used for multi-link aggregation.

In a possible implementation, the second data frame further carries a second receive address, a second transmit address, second Ethertype information, and first payload type information, the second receive address is a SAP address of the STA, the second transmit address is a MAC address of the first AP, the second Ethertype information indicates to process the first payload type information and the payload by using the 802.11 MAC protocol, and the first payload type information indicates that the payload includes a data frame used for multi-link aggregation.

It should be understood that the apparatus 400 herein is embodied in a form of a functional unit. The term “unit” herein may be an application-specific integrated circuit (application specific integrated circuit, ASIC), an electronic circuit, a processor (for example, a shared processor, a dedicated processor, or a group processor) and a memory that are configured to execute one or more software or firmware programs, a combined logic circuit, and/or another appropriate component supporting the described function. In an optional example, a person skilled in the art may understand that the apparatus 400 may be specifically the first AP in the embodiment of the method 100, and the apparatus 400 may be configured to perform procedures and/or steps corresponding to the first AP in the embodiment of the method 100. To avoid repetition, details are not described herein again.

FIG. 29 is a schematic block diagram of a data transmission apparatus 500 according to an embodiment of this application. The apparatus 500 includes: a receiving unit 510, configured to receive a second data frame sent by a first AP, where the second data frame includes a third data frame, the third data frame carries a second MSDU in a plurality of MSDUs, a sequence number of the second MSDU, and a TID of the second MSDU, TIDs of the plurality of MSDUs are the same, and a sequence number of each of the plurality of MSDUs is allocated based on an obtaining sequence; a generation unit 520, configured to generate a fourth data frame based on the second data frame, where the fourth data frame carries the second MSDU, the sequence number of the second MSDU, and the TID of the second MSDU; and a sending unit 530, configured to send the fourth data frame to the STA, where there is a communication link between the first AP and the STA, the communication link is used to transmit a first data frame, and the first data frame carries a first MSDU in the plurality of MSDUs, a sequence number of the first MSDU, and a TID of the first MSDU.

In a possible implementation, the third data frame further carries a first receive address, a first transmit address, a destination address, and first Ethertype information, the first receive address is a MAC address of a service access point SAP of a multi-link entity to which the STA belongs, the first transmit address is a MAC address of a SAP of a multi-link entity to which the first AP belongs, the destination address is a MAC address of a destination end of the second MSDU, and the first Ethertype information indicates to process payload by using an IP protocol.

In a possible implementation, the second data frame further carries a second receive address, a second transmit address, second Ethertype information, and first payload type information, the second receive address is a MAC address of the second AP, the second transmit address is a MAC address of the first AP, the second Ethertype information indicates to process the first payload type information and the payload by using the 802.11 MAC protocol, and the first payload type information indicates that the payload includes a data frame used for multi-link aggregation.

In a possible implementation, the generation unit 520 is specifically configured to generate the fourth data frame based on the second receive address, the second Ethertype information, and the first payload type information.

In a possible implementation, the fourth data frame further carries a third receive address, a third transmit address, the destination address, and the first Ethertype information. The third receive address is a MAC address of the STA, and the third transmit address is the MAC address of the second AP.

In a possible implementation, the second data frame further carries a second receive address, a second transmit address, second Ethertype information, and first payload type information, the second receive address is a SAP address of the STA, the second transmit address is a MAC address of the first AP, the second Ethertype information indicates to process the first payload type information and the payload by using the 802.11 MAC protocol, and the first payload type information indicates that the payload includes a data frame used for multi-link aggregation.

In a possible implementation, the generation unit 520 is specifically configured to generate the fourth data frame based on the second receive address, the second Ethertype information, and the first payload type information. The fourth data frame includes the third data frame, the second Ethertype information, and the first payload type information.

In a possible implementation, the fourth data frame further carries a third receive address and a third transmit address. The third receive address is a MAC address of the STA, and the third transmit address is the MAC address of the second AP.

It should be understood that the apparatus 500 herein is embodied in a form of a functional unit. The term “unit” herein may be an ASIC, an electronic circuit, a processor (for example, a shared processor, a special purpose processor, or a group processor) configured to execute one or more software or firmware programs, a memory, a combinational logic circuit, and/or another appropriate component that supports the described function. In an optional example, a person skilled in the art may understand that the apparatus 500 may be specifically the second AP in the embodiment of the method 100, and the apparatus 500 may be configured to perform procedures and/or steps corresponding to the second AP in the embodiment of the method 100. To avoid repetition, details are not described herein again.

FIG. 30 is a schematic block diagram of a data transmission apparatus 600 according to an embodiment of this application. The apparatus 600 includes: a generation unit 610, configured to generate a first data frame, where the first data frame carries a first MSDU in a plurality of MSDUs, a sequence number of the first MSDU, and a TID of the first MSDU, TIDs of the plurality of MSDUs are the same, a sequence number of each of the plurality of MSDUs is allocated based on an obtaining sequence, and the generation unit 610 is further configured to generate a second data frame, where the second data frame carries a second MSDU in the plurality of MSDUs, a sequence number of the second MSDU, and a TID of the second MSDU; and a sending unit 620, configured to send the first data frame to a first AP, where the sending unit 620 is further configured to send the second data frame to a second AP.

In a possible implementation, the second data frame further carries a first receive address, a first transmit address, a first destination address, and first Ethertype information, the first receive address is a MAC address of a service access point SAP of a multi-link entity to which the first AP belongs, the first transmit address is a MAC address of a SAP of a multi-link entity to which the STA belongs, the first destination address is a MAC address of a destination end of the second MSDU, and the first Ethertype information indicates to process payload by using an IP protocol.

In a possible implementation, the second data frame includes a third data frame, and the third data frame carries the second MSDU, the sequence number of the second MSDU, and the TID of the second MSDU.

In a possible implementation, the third data frame further carries a first receive address, a first transmit address, a first destination address, and first Ethertype information, the first receive address is a MAC address of a service access point SAP of a multi-link entity to which the first AP belongs, the first transmit address is a MAC address of a SAP of a multi-link entity to which the STA belongs, the first destination address is a MAC address of a destination end of the first MSDU, and the first Ethertype information indicates to process payload by using an IP protocol.

In a possible implementation, the second data frame further carries a second receive address, a second transmit address, a second destination address, second Ethertype information, and first payload type information, the second receive address is a MAC address of the second AP, the second transmit address is a MAC address of the STA, the second destination address is a MAC address of the first AP or the MAC address of the SAP of the multi-link entity to which the first AP belongs, the second Ethertype information indicates to process the first payload type information and the payload by using the 802.11 MAC protocol, and the first payload type information indicates that the payload includes a data frame used for multi-link aggregation.

It should be understood that the apparatus 600 herein is embodied in a form of a functional unit. The term “unit” herein may be an ASIC, an electronic circuit, a processor (for example, a shared processor, a special purpose processor, or a group processor) configured to execute one or more software or firmware programs, a memory, a combinational logic circuit, and/or another appropriate component that supports the described function. In an optional example, a person skilled in the art may understand that the apparatus 600 may be specifically the first STA in the embodiment of the method 200, and the apparatus 600 may be configured to perform procedures and/or steps corresponding to the first STA in the embodiment of the method 200. To avoid repetition, details are not described herein again.

FIG. 31 is a schematic block diagram of a data transmission apparatus 700 according to an embodiment of this application. The apparatus 700 includes: a receiving unit 710, configured to receive a second data frame sent by a STA, where the second data frame carries a second MSDU in a plurality of MSDUs, a sequence number of the second MSDU, and a TID of the second MSDU, TIDs of the plurality of MSDUs are the same, and a sequence number of each of the plurality of MSDUs is allocated based on an obtaining sequence; a generation unit 720, configured to generate a third data frame based on the second data frame, where the third data frame carries the second MSDU, the sequence number of the second MSDU, and the TID of the second MSDU; and a sending unit 730, configured to send the third data frame to the first AP, where there is a communication link between the first AP and the STA, the communication link is used to transmit a first data frame, and the first data frame carries a first MSDU in the plurality of MSDUs, a sequence number of the first MSDU, and a TID of the first MSDU.

In a possible implementation, the second data frame further carries a first receive address, a first transmit address, a first destination address, and first Ethertype information, the first receive address is a MAC address of a service access point SAP of a multi-link entity to which the first AP belongs, the first transmit address is a MAC address of a SAP of a multi-link entity to which the STA belongs, the first destination address is a MAC address of a destination end of the second MSDU, and the first Ethertype information indicates to process payload by using an IP protocol.

In a possible implementation, the generation unit 720 is specifically configured to generate the third data frame based on the first receive address. The third data frame includes the second data frame.

In a possible implementation, the third data frame further carries a second receive address, a second transmit address, second Ethertype information, and first payload type information, the second receive address is a MAC address of the first AP, the second transmit address is a MAC address of the second AP, the second Ethertype information indicates to process the first payload type information and the payload by using the 802.11 MAC protocol, and the first payload type information indicates that the payload includes a data frame used for multi-link aggregation.

In a possible implementation, the second data frame includes a fourth data frame, and the fourth data frame carries the second MSDU, the sequence number of the second MSDU, and the TID of the second MSDU.

In a possible implementation, the fourth data frame further carries a first receive address, a first transmit address, a first destination address, and first Ethertype information, the first receive address is a MAC address of a service access point SAP of a multi-link entity to which the first AP belongs, the first transmit address is a MAC address of a SAP of a multi-link entity to which the STA belongs, the first destination address is a MAC address of a destination end of the first MSDU, and the first Ethertype information indicates to process payload by using an IP protocol.

In a possible implementation, the second data frame further carries a second receive address, a second transmit address, a second destination address, second Ethertype information, and first payload type information, the second receive address is a MAC address of the second AP, the second transmit address is a MAC address of the STA, the second destination address is a MAC address of the first AP or the MAC address of the SAP of the multi-link entity to which the first AP belongs, the second Ethertype information indicates to process the first payload type information and the payload by using the 802.11 MAC protocol, and the first payload type information indicates that the payload includes a data frame used for multi-link aggregation.

In a possible implementation, the generation unit 720 is specifically configured to generate the third data frame based on the second receive address, the second destination address, the second Ethertype information, and the first payload type information. The third data frame includes the fourth data frame, the second Ethertype information, and the first payload type information.

In a possible implementation, the third data frame further carries a third receive address and a third transmit address. The third receive address is a MAC address of the first AP, and the third transmit address is the MAC address of the second AP.

It should be understood that the apparatus 700 herein is embodied in a form of a functional unit. The term “unit” herein may be an ASIC, an electronic circuit, a processor (for example, a shared processor, a special purpose processor, or a group processor) configured to execute one or more software or firmware programs, a memory, a combinational logic circuit, and/or another appropriate component that supports the described function. In an optional example, a person skilled in the art may understand that the apparatus 700 may be specifically the second AP in the embodiment of the method 200, and the apparatus 700 may be configured to perform procedures and/or steps corresponding to the second AP in the embodiment of the method 200. To avoid repetition, details are not described herein again.

FIG. 32 is a schematic block diagram of a communication apparatus 800 according to an embodiment of this application. The apparatus 800 includes: a generation unit 810, configured to generate a first data frame, where the first data frame includes a first management frame, the first management frame carries multi-link establishment request information, the multi-link establishment request information is used to request to establish a plurality of communication links to a STA, the plurality of communication links are used to transmit a plurality of MSDUs belonging to a same TID, and there is a proxy AP on at least one of the plurality of communication links; and a sending unit 820, configured to send the first data frame to a first proxy AP, where the at least one communication link includes a communication link to which the first proxy AP belongs.

In a possible implementation, the first management frame further carries a first receive address, a first transmit address, a first destination address, and first Ethertype information, the first receive address is a MAC address of a SAP of a multi-link entity to which the STA belongs, the second transmit address is a MAC address of a SAP of a multi-link entity to which the AP belongs, the first destination address is a MAC address of a destination end of multi-link establishment request information, and the first Ethertype information indicates to process payload by using an IP protocol.

In a possible implementation, the first data frame carries a second receive address, a second transmit address, a second destination address, second Ethertype information, and first payload type information, the second receive address is a MAC address of a relay STA of the first proxy AP, the second transmit address is a MAC address of the AP, the second destination address is a MAC address of the STA or the MAC address of the SAP of the multi-link entity to which the STA belongs, the second Ethertype information indicates to process the first payload type information and the payload by using the 802.11 protocol, and the first payload type information indicates that the payload includes a data frame used for multi-link aggregation.

In a possible implementation, the multi-link establishment request information includes link type information of each of the plurality of communication links, and the link type information indicates whether there is a proxy AP on each communication link.

In a possible implementation, when the plurality of communication links include a first communication link, and there is at least one proxy AP on the first communication link, the multi-link establishment request information further includes first link information, and the first link information includes the MAC address of the service access point SAP of the multi-link entity to which the AP belongs, the MAC address of the SAP of the multi-link entity to which the STA belongs, a quantity of the at least one proxy AP, a MAC address of a relay STA and a MAC address of a relay AP that are of each of the at least one proxy AP.

In a possible implementation, when the plurality of communication links include a second communication link, and there is no proxy AP on the second communication link, the multi-link establishment request information further includes second link information, and the second link information includes a MAC address of a first service access point to which the AP belongs and a MAC address of a second service access point to which the STA belongs.

In a possible implementation, the apparatus 800 further includes a receiving unit 830. The receiving unit 830 is configured to receive a second data frame sent by the STA by using the first proxy AP. The second data frame includes a second management frame, the second management frame carries multi-link establishment response information, and the multi-link establishment response information is used to respond to establishment of the plurality of communication links to the AP.

It should be understood that the apparatus 800 herein is embodied in a form of a functional unit. The term “unit” herein may be an ASIC, an electronic circuit, a processor (for example, a shared processor, a special purpose processor, or a group processor) configured to execute one or more software or firmware programs, a memory, a combinational logic circuit, and/or another appropriate component that supports the described function. In an optional example, a person skilled in the art may understand that the apparatus 800 may be specifically the first AP in the embodiment of the method 300, and the apparatus 800 may be configured to perform procedures and/or steps corresponding to the first AP in the embodiment of the method 300. To avoid repetition, details are not described herein again.

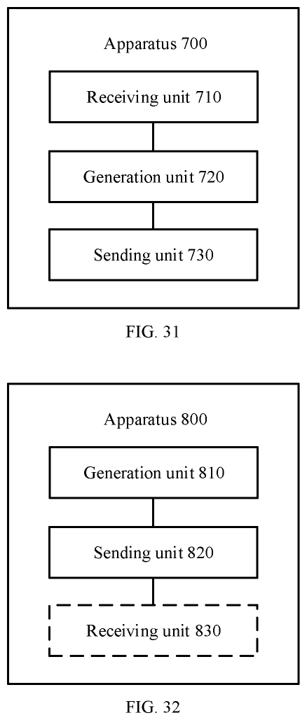

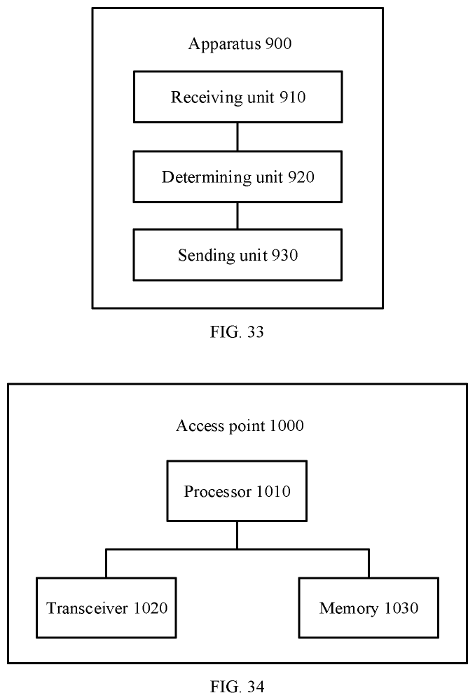

FIG. 33 is a schematic block diagram of a communication apparatus 900 according to an embodiment of this application. The apparatus 900 includes: a receiving unit 910, configured to receive a first data frame sent by an AP, where the first data frame includes a first management frame, the first management frame carries multi-link establishment request information, the multi-link establishment request information is used to request to establish a plurality of communication links to a STA, the plurality of communication links are used to transmit a plurality of MSDUs belonging to a same TID, there is a proxy AP on at least one of the plurality of communication links, and the at least one communication link includes a communication link to which the first proxy AP belongs; a determining unit 920, configured to determine a second data frame based on the first data frame, where the second data frame includes the first management frame; and a sending unit 930, configured to send the second data frame to the STA.

In a possible implementation, the first management frame further carries a first receive address, a first transmit address, a first destination address, and first Ethertype information, the first receive address is a MAC address of a SAP of a multi-link entity to which the STA belongs, the second transmit address is a MAC address of a SAP of a multi-link entity to which the AP belongs, the first destination address is a MAC address of a destination end of multi-link establishment request information, and the first Ethertype information indicates to process payload by using an IP protocol.

In a possible implementation, the first data frame carries a second receive address, a second transmit address, a second destination address, second Ethertype information, and first payload type information, the second receive address is a MAC address of a relay STA of the first proxy AP, the second transmit address is a MAC address of the AP, the second destination address is a MAC address of the STA or the MAC address of the SAP of the multi-link entity to which the STA belongs, the second Ethertype information indicates to process the first payload type information and the payload by using the 802.11 protocol, and the first payload type information indicates that the payload includes a data frame used for multi-link aggregation.

In a possible implementation, the determining unit 920 is specifically configured to generate the second data frame based on the second receive address, the second destination address, the second Ethertype information, and the first payload type information. The second data frame carries the second Ethertype information and the first payload type information.

In a possible implementation, the second data frame further carries a third receive address and a third transmit address. The third receive address is a MAC address of the STA, and the third transmit address is a MAC address of a relay AP of the first proxy AP.

In a possible implementation, the multi-link establishment request information includes link type information of each of the plurality of communication links, and the link type information indicates whether there is a proxy AP on each communication link.

In a possible implementation, when the plurality of communication links include a first communication link, and there is at least one proxy AP on the first communication link, the multi-link establishment request information further includes first link information, and the first link information includes the MAC address of the service access point SAP of the multi-link entity to which the AP belongs, the MAC address of the SAP of the multi-link entity to which the STA belongs, a quantity of the at least one proxy AP, a MAC address of a relay STA and a MAC address of a relay AP that are of each of the at least one proxy AP.

In a possible implementation, when the plurality of communication links include a second communication link, and there is no proxy AP on the second communication link, the multi-link establishment request information further includes second link information, and the second link information includes a MAC address of a first service access point to which the AP belongs and a MAC address of a second service access point to which the STA belongs.

In a possible implementation, the receiving unit 910 is further configured to receive a third data frame sent by the STA based on the second data frame. The third data frame includes a second management frame, the second management frame carries multi-link establishment response information, and the multi-link establishment response information is used to respond to establishment of the plurality of communication links to the AP.

It should be understood that the apparatus 900 herein is embodied in a form of a functional unit. The term “unit” herein may be an ASIC, an electronic circuit, a processor (for example, a shared processor, a special purpose processor, or a group processor) configured to execute one or more software or firmware programs, a memory, a combinational logic circuit, and/or another appropriate component that supports the described function. In an optional example, a person skilled in the art may understand that the apparatus 900 may be specifically the first proxy AP in the embodiment of the method 300, and the apparatus 900 may be configured to perform procedures and/or steps corresponding to the first proxy AP in the embodiment of the method 300. To avoid repetition, details are not described herein again.

FIG. 34 shows an access point 1000 according to an embodiment of this application. The access point 1000 may include the apparatus 400 in FIG. 28, or the access point 1000 may be the apparatus 400 in FIG. 28. A hardware architecture shown in FIG. 34 may be used for the apparatus 400. The access point 1000 may include a processor 1010, a transceiver 1020, and a memory 1030. The processor 1010, the transceiver 1020, and the memory 1030 communicate with each other by using an internal connection path. A related function implemented by the generation unit 410 in FIG. 28 may be implemented by the processor 1010, and a related function implemented by the sending unit 420 may be implemented by the processor 1010 by controlling the transceiver 1020.

The processor 1010 may include one or more processors, for example, include one or more central processing units (central processing unit, CPU). When the processor is one CPU, the CPU may be a single-core CPU, or may be a multi-core CPU.

The transceiver 1020 is configured to send and receive data and/or information, and receive data and/or information. The transceiver may include a transmitter and a receiver. The transmitter is configured to send data and/or a signal, and the receiver is configured to receive data and/or a signal.

The memory 1030 includes but is not limited to a random access memory (random access memory, RAM), a read-only memory (read-only memory, ROM), an erasable programmable read-only memory (erasable programmable read only memory, EPROM), and a compact disc read-only memory (compact disc read-only memory, CD-ROM). The memory 1030 is configured to store related instructions and data.

The memory 1030 is configured to store program code and data of the apparatus, and may be a separate device or integrated into the processor 1010.

Specifically, the processor 1010 is configured to control the transceiver to perform signal transmission with a second AP or a STA. For details, refer to the description in the method embodiment, and details are not described herein again.

It may be understood that FIG. 34 shows only a simplified design of the access point 1000. In actual application, the access point 1000 may further include another necessary component, including but not limited to any quantity of transceivers, processors, controllers, memories, and the like, and all apparatuses that can implement this application fall within the protection scope of this application.

In a possible design, the access point 1000 may be replaced with a chip apparatus, for example, may be a communication chip that can be used in the apparatus, and is configured to implement a related function of the processor in the apparatus. The chip apparatus may be a field programmable gate array, a dedicated integrated chip, a system chip, a central processing unit, a network processor, a digital signal processing circuit, a microcontroller, a programmable controller, or another integrated chip for implementing a related function. Optionally, the chip may include one or more memories, configured to store program code, and when the code is executed, a processor is enabled to implement a corresponding function.

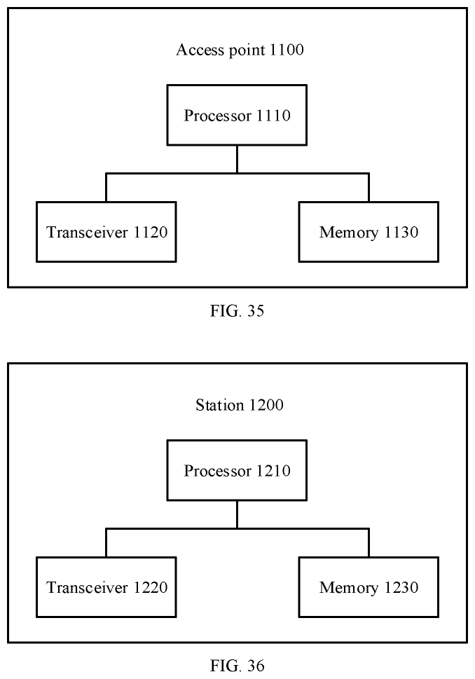

FIG. 35 shows an access point 1100 according to an embodiment of this application. The access point 1100 may be the apparatus 500 in FIG. 29, or the access point 1100 may include the apparatus 500 in FIG. 29. A hardware architecture shown in FIG. 35 may be used for the apparatus 500. The access point 1100 may include a processor 1110, a transceiver 1120, and a memory 1130. The processor 1110, the transceiver 1120, and the memory 1130 communicate with each other by using an internal connection path. A related function implemented by the generation unit 520 in FIG. 29 may be implemented by the processor 1110, and related functions implemented by the receiving unit 510 and the sending unit 530 may be implemented by the processor 1110 by controlling the transceiver 1120.

The processor 1110 may include one or more processors, for example, one or more CPUs. When the processor is one CPU, the CPU may be a single-core CPU or may be a multi-core CPU.

The transceiver 1120 is configured to send and receive data and/or information, and receive data and/or information. The transceiver may include a transmitter and a receiver. The transmitter is configured to send data and/or information, and the receiver is configured to receive data and/or information.

The memory 1130 includes but is not limited to a RAM, a ROM, an EPROM, and a CD-ROM. The memory 1130 is configured to store related instructions and related data.

The memory 1130 is configured to store program code and data of the apparatus, and may be a separate device or integrated into the processor 1110.

Specifically, the processor 1110 is configured to control the transceiver to perform signal transmission with a first AP or a STA. For details, refer to the description in the method embodiment, and details are not described herein again.

It may be understood that FIG. 35 shows only a simplified design of the access point 1100. In actual application, the access point 1100 may further include another necessary component, including but not limited to any quantity of transceivers, processors, controllers, memories, and the like, and all apparatuses that can implement this application fall within the protection scope of this application.

In a possible design, the access point 1100 may be replaced with a chip apparatus, for example, may be a communication chip that can be used in the apparatus, and is configured to implement a related function of the processor in the apparatus. The chip apparatus may be a field programmable gate array, a dedicated integrated chip, a system chip, a central processing unit, a network processor, a digital signal processing circuit, a microcontroller, a programmable controller, or another integrated chip for implementing a related function. Optionally, the chip may include one or more memories, configured to store program code, and when the code is executed, a processor is enabled to implement a corresponding function.

FIG. 36 shows a station 1200 according to an embodiment of this application. The station 1200 may be the apparatus 600 in FIG. 30, or the station 1200 may include the apparatus 600 in FIG. 30. A hardware architecture shown in FIG. 36 may be used for the apparatus 600. The station 1200 may include a processor 1210, a transceiver 1220, and a memory 1230. The processor 1210, the transceiver 1220, and the memory 1230 communicate with each other by using an internal connection path. A related function implemented by the generation unit 610 in FIG. 30 may be implemented by the processor 1210, and a related function implemented by the sending unit 620 may be implemented by the processor 1210 by controlling the transceiver 1220.

The processor 1210 may include one or more processors, for example, one or more CPUs. When the processor is one CPU, the CPU may be a single-core CPU or may be a multi-core CPU.

The transceiver 1220 is configured to send and receive data and/or information, and receive data and/or information. The transceiver may include a transmitter and a receiver. The transmitter is configured to send data and/or information, and the receiver is configured to receive data and/or information.

The memory 1230 includes but is not limited to a RAM, a ROM, an EPROM, and a CD-ROM. The memory 1230 is configured to store related instructions and related data.

The memory 1230 is configured to store program code and data of the apparatus, and may be a separate device or integrated into the processor 1210.

Specifically, the processor 1210 is configured to control the transceiver to perform signal transmission with a first AP or a second AP. For details, refer to the description in the method embodiment, and details are not described herein again.

It may be understood that FIG. 36 shows only a simplified design of the station 1200. In actual application, the station 1200 may further include another necessary component, including but not limited to any quantity of transceivers, processors, controllers, memories, and the like, and all apparatuses that can implement this application fall within the protection scope of this application.

In a possible design, the station 1200 may be replaced with a chip apparatus, for example, may be a communication chip that can be used in the apparatus, and is configured to implement a related function of the processor in the apparatus. The chip apparatus may be a field programmable gate array, a dedicated integrated chip, a system chip, a central processing unit, a network processor, a digital signal processing circuit, a microcontroller, a programmable controller, or another integrated chip for implementing a related function. Optionally, the chip may include one or more memories, configured to store program code, and when the code is executed, a processor is enabled to implement a corresponding function.

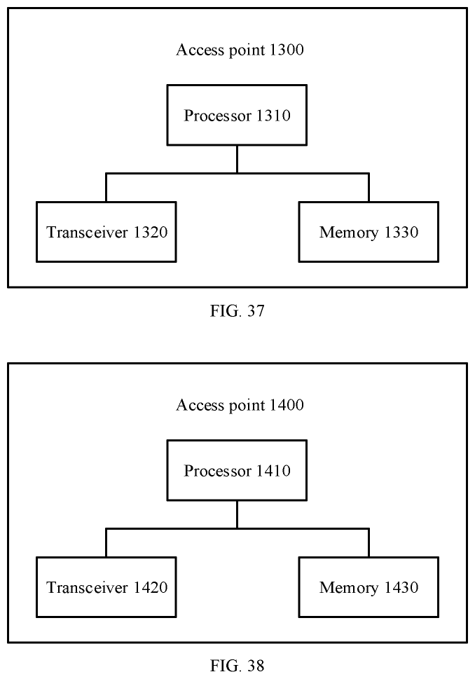

FIG. 37 shows an access point 1300 according to an embodiment of this application. The access point 1300 may be the apparatus 700 in FIG. 31, or the access point 1300 may include the apparatus 700 in FIG. 31. A hardware architecture shown in FIG. 37 may be used for the apparatus 700. The access point 1300 may include a processor 1310, a transceiver 1320, and a memory 1330. The processor 1310, the transceiver 1320, and the memory 1330 communicate with each other by using an internal connection path. A related function implemented by the generation unit 720 in FIG. 31 may be implemented by the processor 1310, and related functions implemented by the receiving unit 710 and the sending unit 730 may be implemented by the processor 1310 by controlling the transceiver 1320.

The processor 1310 may include one or more processors, for example, one or more CPUs. When the processor is one CPU, the CPU may be a single-core CPU or may be a multi-core CPU.

The transceiver 1320 is configured to send and receive data and/or information, and receive data and/or information. The transceiver may include a transmitter and a receiver. The transmitter is configured to send data and/or information, and the receiver is configured to receive data and/or information.

The memory 1330 includes but is not limited to a RAM, a ROM, an EPROM, and a CD-ROM. The memory 1330 is configured to store related instructions and related data.

The memory 1330 is configured to store program code and data of the apparatus, and may be a separate device or integrated into the processor 1310.

Specifically, the processor 1310 is configured to control the transceiver to perform signal transmission with a first AP or a STA. For details, refer to the description in the method embodiment, and details are not described herein again.

It may be understood that FIG. 37 shows only a simplified design of the access point 1300. In actual application, the access point 1300 may further include another necessary component, including but not limited to any quantity of transceivers, processors, controllers, memories, and the like, and all apparatuses that can implement this application fall within the protection scope of this application.

In a possible design, the access point 1300 may be replaced with a chip apparatus, for example, may be a communication chip that can be used in the apparatus, and is configured to implement a related function of the processor in the apparatus. The chip apparatus may be a field programmable gate array, a dedicated integrated chip, a system chip, a central processing unit, a network processor, a digital signal processing circuit, a microcontroller, a programmable controller, or another integrated chip for implementing a related function. Optionally, the chip may include one or more memories, configured to store program code, and when the code is executed, a processor is enabled to implement a corresponding function.

FIG. 38 shows an access point 1400 according to an embodiment of this application. The access point 1400 may be the apparatus 800 in FIG. 32, or the access point 1400 may include the apparatus 800 in FIG. 32. A hardware architecture shown in FIG. 38 may be used for the apparatus 800. The access point 1400 may include a processor 1410, a transceiver 1420, and a memory 1430. The processor 1410, the transceiver 1420, and the memory 1430 communicate with each other by using an internal connection path. A related function implemented by the generation unit 810 in FIG. 32 may be implemented by the processor 1410, and related functions implemented by the receiving unit 830 and the sending unit 820 may be implemented by the processor 1410 by controlling the transceiver 1420.

The processor 1410 may include one or more processors, for example, one or more CPUs. When the processor is one CPU, the CPU may be a single-core CPU or may be a multi-core CPU.

The transceiver 1420 is configured to send and receive data and/or information, and receive data and/or information. The transceiver may include a transmitter and a receiver. The transmitter is configured to send data and/or information, and the receiver is configured to receive data and/or information.

The memory 1430 includes but is not limited to a RAM, a ROM, an EPROM, and a CD-ROM. The memory 1430 is configured to store related instructions and related data.

The memory 1430 is configured to store program code and data of the apparatus, and may be a separate device or integrated into the processor 1410.

Specifically, the processor 1410 is configured to control the transceiver to perform signal transmission with a first proxy AP or a STA. For details, refer to the description in the method embodiment, and details are not described herein again.

It may be understood that FIG. 38 shows only a simplified design of the access point 1400. In actual application, the access point 1400 may further include another necessary component, including but not limited to any quantity of transceivers, processors, controllers, memories, and the like, and all apparatuses that can implement this application fall within the protection scope of this application.

In a possible design, the access point 1400 may be replaced with a chip apparatus, for example, may be a communication chip that can be used in the apparatus, and is configured to implement a related function of the processor in the apparatus. The chip apparatus may be a field programmable gate array, a dedicated integrated chip, a system chip, a central processing unit, a network processor, a digital signal processing circuit, a microcontroller, a programmable controller, or another integrated chip for implementing a related function. Optionally, the chip may include one or more memories, configured to store program code, and when the code is executed, a processor is enabled to implement a corresponding function.

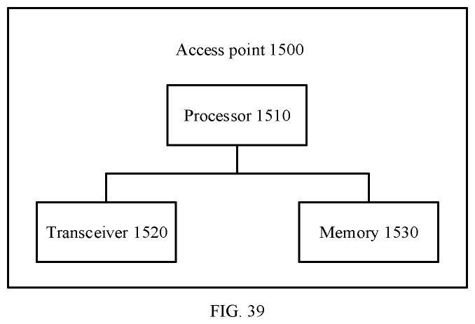

FIG. 39 shows an access point 1500 according to an embodiment of this application. The access point 1500 may be the apparatus 900 in FIG. 33, or the access point 1500 may include the apparatus 900 in FIG. 33. A hardware architecture shown in FIG. 39 may be used for the apparatus 900. The access point 1500 may include a processor 1510, a transceiver 1520, and a memory 1530. The processor 1510, the transceiver 1520, and the memory 1530 communicate with each other by using an internal connection path. A related function implemented by the determining unit 920 in FIG. 33 may be implemented by the processor 1510, and related functions implemented by the receiving unit 910 and the sending unit 930 may be implemented by the processor 1510 by controlling the transceiver 1520.

The processor 1510 may include one or more processors, for example, one or more CPUs. When the processor is one CPU, the CPU may be a single-core CPU or may be a multi-core CPU.

The transceiver 1520 is configured to send and receive data and/or information, and receive data and/or information. The transceiver may include a transmitter and a receiver. The transmitter is configured to send data and/or information, and the receiver is configured to receive data and/or information.

The memory 1530 includes but is not limited to a RAM, a ROM, an EPROM, and a CD-ROM. The memory 1530 is configured to store related instructions and related data.

The memory 1530 is configured to store program code and data of the apparatus, and may be a separate device or integrated into the processor 1510.

Specifically, the processor 1510 is configured to control the transceiver to perform signal transmission with an AP or a STA. For details, refer to the description in the method embodiment, and details are not described herein again.

It may be understood that FIG. 39 shows only a simplified design of the access point 1500. In actual application, the access point 1500 may further include another necessary component, including but not limited to any quantity of transceivers, processors, controllers, memories, and the like, and all apparatuses that can implement this application fall within the protection scope of this application.

In a possible design, the access point 1500 may be replaced with a chip apparatus, for example, may be a communication chip that can be used in the apparatus, and is configured to implement a related function of the processor in the apparatus. The chip apparatus may be a field programmable gate array, a dedicated integrated chip, a system chip, a central processing unit, a network processor, a digital signal processing circuit, a microcontroller, a programmable controller, or another integrated chip for implementing a related function. Optionally, the chip may include one or more memories, configured to store program code, and when the code is executed, a processor is enabled to implement a corresponding function.

Based on the foregoing description of the implementations, a person skilled in the art may clearly understand that for the purpose of convenient and brief description, division into the foregoing function modules is merely used as an example for description. In actual application, the foregoing functions can be allocated to different function modules for implementation based on a requirement, that is, an inner structure of an apparatus is divided into different function modules to implement all or some of the functions described above. For detailed working processes of the foregoing system, apparatus, and unit, refer to corresponding processes in the foregoing method embodiments, and details are not described herein again.

Functional units in embodiments of this application may be integrated into one processing unit, or each of the units may exist alone physically, or two or more units are integrated into one unit. The integrated unit may be implemented in a form of hardware, or may be implemented in a form of a software function unit.

When the integrated unit is implemented in the form of the software functional unit and is sold or used as an independent product, the integrated unit may be stored in a computer-readable storage medium. Based on such an understanding, the technical solutions of embodiments of this application essentially, or the part contributing to the prior art, all or some of the technical solutions may be implemented in a form of a software product. The computer software product is stored in a storage medium, and includes several instructions for instructing a computer device (which may be a personal computer, a server, or a network device) or a processor to perform all or some of the steps of the methods described in embodiments of this application. The foregoing storage medium includes any medium that can store program code, such as a flash memory, a removable hard disk, a read-only memory, a random access memory, a magnetic disk, or an optical disc.

The foregoing description is merely a specific implementation of the embodiments of this application, but is not intended to limit the protection scope of the embodiments of this application. Any variation or replacement within the technical scope disclosed in embodiments of this application shall fall within the protection scope of embodiments of this application. Therefore, the protection scope of embodiments of this application shall be subject to the protection scope of the claims.

What is claimed is:

1. A data transmission method, comprising:
generating, by a first access point (AP), a first data frame, wherein the first data frame carries a first media access control service data unit (MSDU), a sequence number of the first MSDU, and a traffic identifier (TID) of the first MSDU;
generating, by the first AP, a second data frame, wherein the second data frame comprises a third data frame, the third data frame carries a second MSDU, a sequence number of the second MSDU, and a TID of the second MSDU, the TID of the first MSDU is the same as the TID of the second MSDU, and the sequence number of the first MSDU and the sequence number of the second MSDU are allocated based on an obtaining sequence;
sending, by the first AP, the first data frame to a station STA; and
sending, by the first AP, the second data frame to a second AP.

2. The method according to claim 1, wherein the third data frame further carries a first receive address, a first transmit address, a source address, and first Ethertype information, the first receive address is a MAC address of a service access point (SAP) of a multi-link entity to which the STA belongs, the first transmit address is a MAC address of a SAP of a multi-link entity to which the first AP belongs, the source address is a MAC address of a source end of the second MSDU, and the first Ethertype information indicates to process payload by using an IP protocol.

3. The method according to claim 1, wherein the second data frame further carries a second receive address, a second transmit address, second Ethertype information, and first payload type information, the second receive address is a MAC address of the second AP, the second transmit address is a MAC address of the first AP, the second Ethertype information indicates to process the first payload type information and the payload by using the 802.11 MAC protocol, and the first payload type information indicates that the payload comprises a data frame used for multi-link aggregation.

4. The method according to claim 1, wherein the second data frame further carries a second receive address, a second transmit address, second Ethertype information, and first payload type information, the second receive address is a SAP address of the STA, the second transmit address is a MAC address of the first AP, the second Ethertype information indicates to process the first payload type information and the payload by using the 802.11 MAC protocol, and the first payload type information indicates that the payload comprises a data frame used for multi-link aggregation.

5. A data transmission method, comprising:
receiving, by a second access point (AP), a second data frame sent by a first AP, wherein the second data frame comprises a third data frame, and the third data frame carries a second media access control service data unit (MSDU), a sequence number of the second MSDU, and a traffic identifier (TID) of the second MSDU;
generating, by the second AP, a fourth data frame based on the second MSDU, the sequence number of the second MSDU, and the TID of the second MSDU, wherein the fourth data frame carries the second MSDU, the sequence number of the second MSDU, and the TID of the second MSDU; and
sending, by the second AP, the fourth data frame to a station (STA), wherein there is a communication link between the first AP and the STA, the communication link is used to transmit a first data frame, the first data frame carries a first MSDU, a sequence number of the first MSDU, and a TID of the first MSDU, the TID of the first MSDU is the same as the TID of the second MSDU, and the sequence number of the first MSDU and the sequence number of the second MSDU are allocated based on an obtaining sequence of the first AP.

6. The method according to claim 5, wherein the third data frame further carries a first receive address, a first transmit address, a source address, and first Ethertype information, the first receive address is a MAC address of a service access point (SAP) of a multi-link entity to which the STA belongs, the first transmit address is a MAC address of a SAP of a multi-link entity to which the first AP belongs, the source address is a MAC address of a source end of the second MSDU, and the first Ethertype information indicates to process payload by using an IP protocol.

7. The method according to claim 5, wherein the second data frame further carries a second receive address, a second transmit address, second Ethertype information, and first payload type information, the second receive address is a MAC address of the second AP, the second transmit address is a MAC address of the first AP, the second Ethertype information indicates to process the first payload type information and the payload by using the 802.11 MAC protocol, and the first payload type information indicates that the payload comprises a data frame used for multi-link aggregation.

8. The method according to claim 7, wherein the generating, by the second AP, a fourth data frame based on the second MSDU, the sequence number of the second MSDU, and the TID of the second MSDU comprises: generating, by the second AP, the fourth data frame based on the second MSDU, the sequence number of the second MSDU, the TID of the second MSDU, the second receive address, the second Ethertype information, and the first payload type information.

9. The method according to claim 8, wherein the fourth data frame further carries a third receive address, a third transmit address, the source address, and the first Ethertype information, the third receive address is a MAC address of the STA, and the third transmit address is the MAC address of the second AP.

10. The method according to claim 5, wherein the second data frame further carries a second receive address, a second transmit address, second Ethertype information, and first payload type information, the second receive address is a SAP address of the STA, the second transmit address is a MAC address of the first AP, the second Ethertype information indicates to process the first payload type information and the payload by using the 802.11 MAC protocol, and the first payload type information indicates that the payload comprises a data frame used for multi-link aggregation.

11. The method according to claim 10, wherein the generating, by the second AP, a fourth data frame based on the second MSDU, the sequence number of the second MSDU, and the TID of the second MSDU comprises: generating, by the second AP, the fourth data frame based on the second MSDU, the sequence number of the second MSDU, the TID of the second MSDU, the second receive address, the second Ethertype information, and the first payload type information, wherein the fourth data frame comprises the third data frame, the second Ethertype information, and the first payload type information.

12. The method according to claim 11, wherein the fourth data frame further carries a third receive address and a third transmit address, the third receive address is a MAC address of the STA, and the third transmit address is a MAC address of the second AP.

13. A data transmission method, comprising:
generating, by a station (STA), a first data frame, wherein the first data frame carries a first media access control service data unit (MSDU), a sequence number of the first MSDU, and a traffic identifier (TID) of the first MSDU;
generating, by the STA, a second data frame, wherein the second data frame carries a second MSDU, a sequence number of the second MSDU, and a TID of the second MSDU, the TID of the first MSDU is the same as the TID of the second MSDU, and the sequence number of the first MSDU and the sequence number of the second MSDU are allocated based on an obtaining sequence;
sending, by the STA, the first data frame to a first AP; and
sending, by the STA, the second data frame to a second AP.

14. The method according to claim 13, wherein the second data frame further carries a first receive address, a first transmit address, a first destination address, and first Ethertype information, the first receive address is a MAC address of a service access point (SAP) of a multi-link entity to which the first AP belongs, the first transmit address is a MAC address of a SAP of a multi-link entity to which the STA belongs, the first destination address is a MAC address of a destination end of the second MSDU, and the first Ethertype information indicates to process payload by using an IP protocol.

15. The method according to claim 13, wherein the second data frame comprises a third data frame, and the third data frame carries the second MSDU, the sequence number of the second MSDU, and the TID of the second MSDU.

16. The method according to claim 15, wherein the third data frame further carries a first receive address, a first transmit address, a first destination address, and first Ethertype information, the first receive address is a MAC address of a service access point (SAP) of a multi-link entity to which the first AP belongs, the first transmit address is a MAC address of a SAP of a multi-link entity to which the STA belongs, the first destination address is a MAC address of a destination end of the first MSDU, and the first Ethertype information indicates to process payload by using an IP protocol.

17. The method according to claim 15, wherein the second data frame further carries a second receive address, a second transmit address, a second destination address, second Ethertype information, and first payload type information, the second receive address is a MAC address of the second AP, the second transmit address is a MAC address of the STA, the second destination address is a MAC address of the first AP or the MAC address of the SAP of the multi-link entity to which the first AP belongs, the second Ethertype information indicates to process the first payload type information and the payload by using the 802.11 MAC protocol, and the first payload type information indicates that the payload comprises a data frame used for multi-link aggregation.
